(19) United States
(12) Patent Application Publication
(10) Pub. No.: US 2011/0125790 A1
(43) Pub. Date: May 26, 2011

(54) METHOD AND APPARATUS FOR REPRESENTING SENSORY EFFECTS AND COMPUTER READABLE RECORDING MEDIUM STORING SENSORY EFFECT METADATA

(76) Inventors: Bum-Suk Choi, Daejon (KR); Sanghyun Joo, Daejon (KR); Hae-Ryong Lee, Daejon (KR); Seungsoon Park, Seoul (KR); Kwang-Roh Park, Daejon (KR)

(21) Appl. No.: 13/054,700

(22) PCT Filed: Jul. 16, 2009
(86) PCT No.: PCT/KR2009/003943

§ 371 Date: Jan. 18, 2011

Related U.S. Application Data
(60) Provisional application No. 61/081,358, filed on Jul. 16, 2008.

(51) Int. Cl. G06F 17/30

(52) U.S. Cl. 707/769; 707/E17.014

(57) ABSTRACT

Provided are method and apparatus for representing sensory effects, and a computer readable recording medium storing sensory effect metadata. A method for generating sensory effect media, includes: receiving sensory effect information about sensory effects applied to media; and generating sensory effect metadata including the received sensory effect information, wherein the sensory effect metadata includes sensory effect description information for describing the sensory effects and the sensory effect description information includes media location information that describes locations in the media where the sensory effects are applied to.

### TECHNICAL FIELD

The present invention relates to a method and apparatus for representing sensory effects, and a computer readable recording medium storing sensory effect metadata.

### BACKGROUND ART

In general, media includes audio and video. The audio may be voice or sound and the video may be a still image and a moving image. When a user consumes or reproduces media, a user uses metadata to obtain information about media. Here, the metadata is data about media. Meanwhile, a device for reproducing media has been advanced from devices reproducing media recorded in an analog format to devices reproducing media recorded in a digital format.

An audio output device such as speakers and a video output device such as a display device have been used to reproduce media.

FIG. 1 is a diagram for schematically describing a media technology according to the related art. As shown in FIG. 1, media is outputted to a user using a media reproducing device 104. The media reproducing device 104 according to the related art include only devices for outputting audio and video. Such a conventional service is referred as a single media single device (SMSD) based service in which one media is reproduced through one device.

Meanwhile, audio and video technologies have been advanced to effectively provide media to a user. For example, an audio technology has been developed to process an audio signal to a multi-channel signal or a multi-object signal or a display technology also has been advanced to process video to a high quality video, a stereoscopic video, and a three dimensional image.

Related to a media technology, a moving picture experts group (MPEG) has introduced MPEG-1, MPEG-2, MPEG-4, MPEG-7, and MPEG-21 and has developed new media concept and multimedia processing technology. MPEG-1 defines a formation for storing audio and video and MPEG-2 defines specification about audio transmission. MPEG-4 defines an object-based media structure. MPEG-7 defines specification about metadata related to media, and MPEG-21 defines media distribution framework technology.

Although realistic experiences can be provided to a user through 3-D audio/video devices due to the development of the media technology, it is very difficult to realize sensory effects only with audio/video devices and media.

### DISCLOSURE

### Technical Problem

An embodiment of the present invention is directed to providing a method and apparatus for representing sensory effects in order to maximize media reproducing effects by realizing sensory effects when media is reproduced.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for generating sensory effect media, the method comprising: receiving sensory effect information about sensory effects applied to media; and generating sensory effect metadata including the received sensory effect information, wherein the sensory effect metadata includes sensory effect description information for describing the sensory effects and the sensory effect description information includes media location information that describes locations in the media where the sensory effects are applied to.

In accordance with another aspect of the present invention, there is provided an apparatus for generating sensory media, the apparatus comprising: an input unit configured to receive sensory effect information about sensory effects applied to media; and a sensory effect metadata generator configured to generate sensory effect metadata including the received sensory effect information, wherein the sensory effect metadata includes sensory effect description information for describing the sensory effects and the sensory effect description information includes media location information that describes locations in the media where the sensory effects are applied to.

In accordance with another aspect of the present invention, there is provided a method for representing sensory effects, the method comprising: receiving sensory effect metadata including sensory effect information about sensory effects applied to media; obtaining the sensory effect information by analyzing the sensory effect metadata; and generating sensory device command metadata for controlling sensory devices corresponding to the sensory effect information, wherein the sensory effect metadata includes sensory effect description information for describing the sensory effects, and the sensory effect description information includes media location information that describes locations in the media where the sensory effects are applied to.

In accordance with another aspect of the present invention, there is provided an apparatus for representing sensory effects, the apparatus comprising: an input unit configured to receive sensory effect metadata including sensory effect information about sensory effects applied to media; and a controlling unit configured to obtain the sensory effect information by analyzing the sensory effect metadata and generate sensory device command metadata for controlling sensory devices corresponding to the sensory effect information, wherein the sensory effect metadata includes sensory effect description information that describes the sensory effects, and the sensory effect description information includes media location information that describes locations in the media where the sensory effects are applied to.

In accordance with another aspect of the present invention, there is provided a computer readable recording medium storing metadata, the metadata comprising: sensory effect metadata including sensory effect information about sensory effects applied to media, wherein the sensory effect metadata includes sensory effect description information that describes the sensory effects and media location information that describes locations in the media where the sensory effects are applied to.

### Advantageous Effects

A method and apparatus for reproducing sensory effects can maximize media reproducing effects by realizing sensory effects when media is reproduced.

### BRIEF DESCRIPTION OF THE DRAWINGS

FIG. 1 is a schematic diagram illustrating a media technology according to the related art.

FIG. 2 is a conceptual diagram illustrating realizing sensor effect media in accordance with an embodiment of the present invention.

FIG. 3 is a diagram illustrating a single media multiple device (SMMD) system for representing sensory effects in accordance with an embodiment of the present invention.

FIG. 4 is a diagram illustrating a sensory media generator in accordance with an embodiment of the present invention.

FIG. 5 is a block diagram illustrating an apparatus for representing sensory effects in accordance with an embodiment of the present invention.

FIG. 6 is block diagram illustrating an apparatus for providing sensory device capability information in accordance with an embodiment of the present invention.

FIG. 7 is a block diagram illustrating an apparatus for providing user sensory preference information in accordance with an embodiment of the present invention.

FIG. 8 is a diagram illustrating relation between a contents structure and a schema structure.

FIG. 9 is a diagram illustrating a procedure of processing sensory effect metadata.

FIG. 10 is a diagram illustrating a procedure of combining sensory effects.

FIG. 11 is a diagram illustrating a structure of effect variable for describing expandability of sensory effect metadata in accordance with an embodiment of the present invention.

FIG. 12 is a diagram illustrating sensory effect metadata in accordance with an embodiment of the present invention.

FIG. 13 is a diagram illustrating general information (GeneralInfo) included in the sensory effect metadata in accordance with an embodiment of the present invention,

FIG. 14 is a diagram illustrating sensory effect description information (SEDescription) included in sensory effect metadata in accordance with an embodiment of the present invention.

FIG. 15 is a diagram illustrating media location information (Locator) included in the sensory effect metadata in accordance with an embodiment of the present invention.

FIG. 16 is a diagram illustrating sensory effect segment information (SESegment) included in sensory effect metadata in accordance with an embodiment of the present invention.

FIG. 17 is a diagram illustrating effect list information (EffectList) included in sensory effect metadata in accordance with an embodiment of the present invention.

FIG. 18 is a diagram illustrating effect variable information (EffectVariable) included in sensory effect metadata in accordance with an embodiment of the present invention.

FIG. 19 is a diagram illustrating sensory effect fragment information (SEFragment) included in sensory effect metadata in accordance with an embodiment of the present invention.

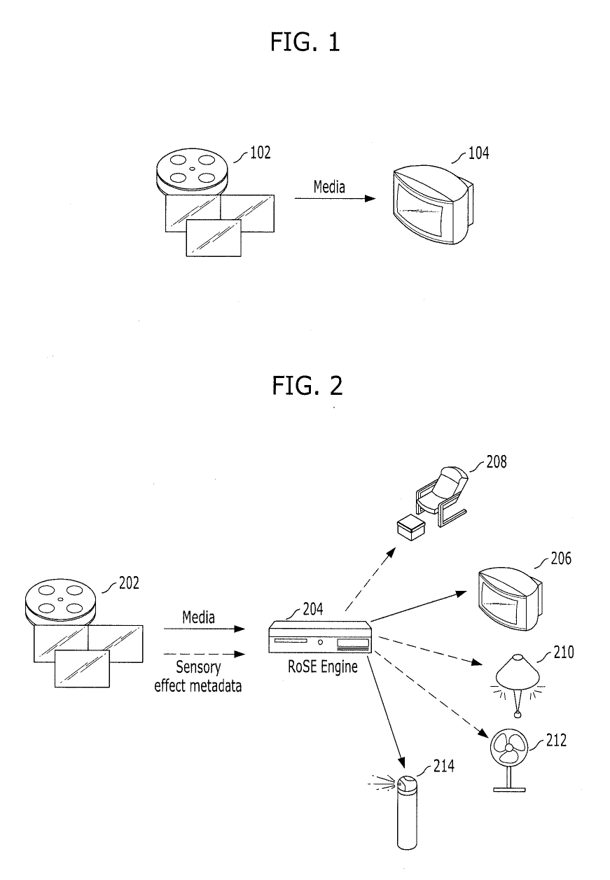

### BEST MODE FOR THE INVENTION

The advantages, features and aspects of the invention will become apparent from the following description of the embodiments with reference to the accompanying drawings, which is set forth hereinafter. In addition, if further detailed description on the related prior arts is determined to obscure the point of the present invention, the description is omitted. Hereafter, preferred embodiments of the present invention will be described in detail with reference to the drawings. The same reference numeral is given to the same element, although the element appears in different drawings.

Conventionally, audio and video are only objects of media generation and consumption such as reproducing. However, human has not only visual and auditory senses but also olfactory and tactile senses. Lately, many studies have been made to develop a device stimulating all of the five senses of human.

Meanwhile, home appliances controlled by an analog signal have been advanced to home appliances controlled by a digital signal.

Media has been limited as audio and video only. The concept of media limited as audio and video may be expanded by controlling devices that stimulate other senses such as olfactory or tactile sense with media incorporated. That is, a media service has been a single media single device (SMSD) based service in which one media is reproduced by one device. However, in order to maximize media reproducing effect in ubiquitous home, a single media multi devices (SMMD) based service may be realized. The SMMD based service reproduces one media through multiple devices.

Therefore, it is necessary to advance a media technology for reproducing media to simply watch and listen to a sensory effect type media technology for representing sensory effects with media reproduced in order to satisfy five senses of human. Such a sensory effect type media may extend a media industry and a market of sensory effect devices and provide rich experience to a user by maximizing media reproducing effect. Therefore, a sensory effect type media may promote the consumption of media.

FIG. 2 is a diagram illustrating realization of sensory effect media in accordance with an embodiment of the present invention.

Referring to FIG. 2, media 202 and sensory effect metadata are input to an apparatus for representing sensory effects. Here, the apparatus for representing sensory effects is also referred as a representation of sensory effect engine (RoSE Engine) 204. Here, the media 202 and the sensory effect metadata may be input to the representation of sensory effect engine (RoSE Engine) 204 by independent providers. For example, a media provider (not shown) may provide media 202 and a sensory effect provider (not shown) may provide the sensory effects metadata.

The media 202 includes audio and video, and the sensory effect metadata includes sensory effect information for representing or realizing sensory effects of media 202. The sensory effect metadata may include all information for maximizing reproducing effects of media 202. FIG. 2 exemplary shows visual sense, olfactory sense, and tactile sense as sensory effects. Therefore, sensory effect information includes visual sense effect information, olfactory sense effect information, and tactile sense effect information.

The RoSE engine 204 receives media 202 and controls a media output device 206 to reproduce the media 202. The RoSE engine 204 controls sensory effect devices 208, 210, 212, and 214 using visual effect information, olfactory effect information, and tactile effect information included in sensory effect metadata. Particularly, the RoSE engine 204 controls lights 210 using the visual effect information, controls a scent device 214 using the olfactory effect information, and controls a trembling chair 208 and a fan 212 using the tactile effect information.

For example, when video including a scene of lightning or thunder is reproduced, lights 210 are controlled to be turned on and off. When video including a scene of foods or a field is reproduced, the scent device 214 is controlled. Further, when video including a scene of water rafting or car chasing is reproduced, the trembling chair 208 and the fan 212 are controlled. Accordingly, sensory effects can be realized corresponding to scenes of video while reproducing.

In order to realize sensory effects, it is necessary to define a schema to express sensory effect information such as intensity of wind, color of light, and intensity of vibration in a standard format. Such a standardized schema for sensory effect information is referred as sensory effect metadata (SEM). When the sensory effect metadata is input to the RoSE engine 204 with the media 202, the RoSE engine 204 analyzes the sensory effect metadata that is described to realize sensory effects at predetermined times while reproducing the media 202. Further, the RoSE engine 204 controls sensory effect devices with being synchronized with the media 202.

The RoSE engine 204 needs to have information about various sensory devices in advance for representing sensory effects. Therefore, it is necessary to define metadata for expressing information about sensory effect devices. Such metadata is referred to as a sensory device capability metadata (SDCap). The sensory device capability metadata includes information about positions, directions, and capabilities of sensory devices.

A user who wants to reproduce media 202 may have various preferences for specific sensory effects. Such a preference may influence representation of sensory effects. For example, a user may not like a red color light. Or, when a user wants to reproduce media 202 in the middle of night, the user may want a dim lighting and a low sound volume. By expressing such preferences of a user about predetermined sensory effects as metadata, various sensory effects may be provided to a user. Such metadata is referred to as user sensory preference metadata (USP).

Before representing sensory effects, the RoSE engine 204 receives sensory effect capability metadata from each of sensory effect devices and user sensory preference metadata through an input device or from sensory effect devices. The RoSE engine 204 controls sensory effect devices with reference to the sensory effect capability metadata and the user sensory preference metadata USP. Such a control command is transferred to each of the sensory devices in a form of metadata. The metadata is referred to as a sensory device command metadata (SDCmd).

Hereinafter, a method and apparatus for representing sensory effects in accordance with an embodiment of the present invention will be described in detail.

### <Definitions of Terms>

1. Provider

The provider is an object that provides sensory effect metadata. The provider may also provide media related to the sensory effect metadata.

For example, the provider may be a broadcasting service provider

2. Representation of Sensory Effect (RoSE) Engine

The RoSE engine is an object that receives sensory effect metadata, sensory device capabilities metadata, user sensory preference metadata, and generates sensory device commands metadata based on the received metadata.

3. Consumer Devices

The consumer device is an object that receives sensory device command metadata and provides sensory device capabilities metadata. Also, the consumer device may be an object that provides user sensory preference metadata. The sensory devices are a sub-set of the consumer devices.

For example, the consumer device may be fans, lights, scent devices, and human input devices such as a television set with a remote controller.

4. Sensory Effects

The sensory effects are effects that augment perception by stimulating senses of human at a predetermined scene of multimedia application.

For example, the sensory effects may be smell, wind, and light.

5. Sensory Effect Metadata (SEM)

The sensory effect metadata (SEM) defines description schemes and descriptors for representing sensory effects

6. Sensory Effect Delivery Format

The sensory effect delivery format defines means for transmitting the sensory effect metadata (SEM).

For example, the sensory effect delivery format may be a MPEG2-TS payload format, a file format, and a RTP payload format.

7. Sensory Devices

The sensory devices are consumer devices for producing corresponding sensory effects.

For example, the sensory devices may be light, fans, and heater.

8. Sensory Device Capability

The sensory device capability defines description schemes and descriptors for representing properties of sensory devices.

For example, the sensory device capability may be a extensible markup language (XML) schema.

9. Sensory Device Capability Delivery Format

The sensory device capability delivery format defines means for transmitting sensory device capability.

For example, the sensory device capability delivery format may be hypertext transfer protocol (HTTP), and universal plug and play (UPnP).

10. Sensory Device Command

The sensory device command defines description schemes and descriptors for controlling sensory devices.

For example, the sensory device command may be a XML schema.

11. Sensory Device Command Delivery Format

The sensory device command delivery format defines means for transmitting the sensory device command.

For example, the sensory device command delivery format may be HTTP and UPnP.

12. User Sensory Preference

The user sensory preference defines description schemes and descriptors for representing user preferences about sensory effects related to rendering sensory effects.

For example, the user sensory preference may be a XML schema.

13. User Sensory Preference Delivery Format

The user sensory preference delivery format defines means for transmitting user sensory preference.

For example, the user sensory preference delivery format may be HTTP and UPnP.

### <System for Representing Sensory Effects>

Hereinafter, an overall structure and operation of a system for representing sensory effects in accordance with an embodiment of the present invention will be described in detail.

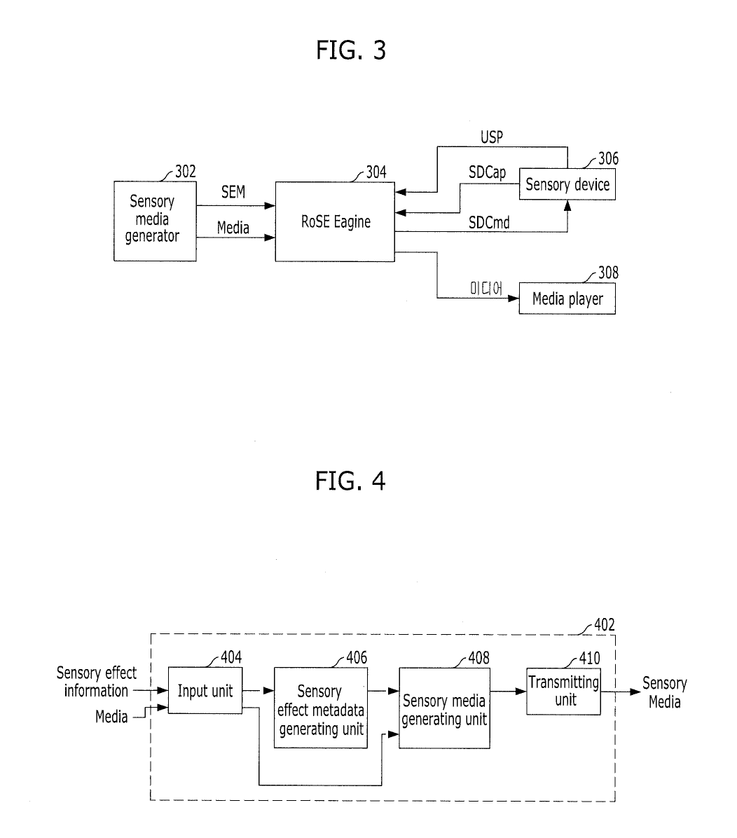

FIG. 3 is a diagram illustrating a single media multiple device (SMMD) system for representing sensory effects in accordance with an embodiment of the present invention.

Referring to FIG. 3, the SMMD system according to the present embodiment includes a sensory media generator 302, a representation of sensory effects (RoSE) engine 304, a sensory device 306, and a media player 308.

The sensory media generator 302 receives sensory effect information about sensory effects applied to media and generates sensory effect metadata (SEM) including the received sensory effect information. Then, the sensory media generator 302 transmits the generated sensory effect metadata to the RoSE engine 304. Here, the sensory media generator 302 may transmit media with the sensory effect metadata.

Although it is not shown in FIG. 3, a sensory media generator 302 according to another embodiment may transmit only sensory effect metadata. Media may be transmitted to the RoSE engine 304 or the media player 308 through additional devices. The sensory media generator 302 generates sensory media by packaging the generated sensory effect metadata with the media and may transmit the generated sensory media to the RoSE engine 304.

The RoSE engine 304 receives sensory effect metadata including sensory effect information about sensory effects applied to media and obtains sensory effect information by analyzing the received sensory effect metadata. The RoSE engine 304 controls the sensory device 306 of a user in order to represent sensory effects while reproducing media using the obtained sensory effect information. In order to control the sensory devices 306, the RoSE engine 304 generate the sensory device command metadata (SDCmd) and transmits the generated sensory device command metadata to the sensory device 306. In FIG. 3, one sensory device 306 is shown for convenience. However, a user may possess a plurality of sensory devices.

In order to generate the sensory device command metadata, the RoSE engine 304 needs information about capabilities of each sensory device 306. Therefore, before generating the sensory device command metadata, the RoSE engine 304 receives sensory device capability metadata (SDCap) that includes the information about capabilities of sensory devices 306. The RoSE engine 304 obtains information about states and capabilities of each sensory device 306 from the sensory device capability metadata. The RoSE engine 304 generates sensory device command metadata for realizing sensory effects that can be realized by each of sensory devices using the obtained information. Here, the controlling the sensory devices include synchronizing the sensory devices with scenes that are reproduced by the media player 308.

In order to control the sensory device 306, the RoSE engine 304 and the sensory device 306 may be connected through networks. Particularly, LonWorks or Universal Plug and Play technologies may be applied as the network technology. In order to effective provide media, media technologies such as MPEG including MPEG-7 and MPEG-21 may be applied together.

A user of the sensory device 306 and the media player 308 may have various preferences about predetermined sensory effects. For example, the user may dislike a predetermined color or may want strong vibration. Such user preference information may be input through the sensory device 306 or an additional input terminal (not shown). Further, the user preference information may be generated in a form of metadata. Such metadata is referred to as user sensory preference metadata USP. The generated user sensory preference metadata is transmitted to the RoSE engine 304 through the sensory device 306 or the input terminal (not shown). The RoSE engine 304 may generate sensory device command metadata in consideration of the received user sensory preference metadata.

The sensory device 306 is a device for realizing sensory effects applied to media. Particularly, the sensory device 306 includes exemplary devices as follows. However, the present invention is not limited thereto.
visual device: monitor, TV, wall screen.
sound device: speaker, music instrument, and bell
wind device: fan, and wind injector.
   temperature device: heater and cooler
   Lighting device: light, dimmer, color LED, and flash
   shading device: curtain, roll screen, and door
   vibration device: trembling chair, joy stick, and ticker
   scent device: perfumer
   diffusion device: sprayer
   other device: devices that produce undefined effects and combination of the above devices

A user may have more than one of sensory devices 306. The sensory devices 306 receive the sensory device command metadata from the RoSE engine 304 and realize sensory effects defined in each scene by synchronizing it with the media.

The media player 308 is a device for reproducing media such as TV. Since the media player 308 is a kind of device for representing video and audio, the media reproduce 308 may be included in the sensory device 306. However, in FIG. 3, the media player 308 is independently shown for convenience. The media player 308 receives media from the RoSE engine 304 or through additional path and reproduces the received media.

### <Method and Apparatus for Generating Sensory Media>

Hereinafter, a method and apparatus for generating sensory media in accordance with an embodiment of the present invention will be described in detail.

The method for generating sensory media according to the present embodiment includes receiving sensory effect information about sensory effects applied to media; and generating sensory effect metadata including the sensory effect information. The sensory effect metadata includes sensory effect description information. The sensory effect description information includes media location information. The media location information describes about locations in media where sensory effects are applied to.

The method for generating sensory media according to the present embodiment further includes transmitting the generated sensory effect metadata to a RoSE engine. The sensory effect metadata may be transmitted as independent data separated from media. For example, when a user requests a movie service, a provider may transmit sensory effect metadata with media data (movie). If a user already has a predetermined media data (movie), a provider may transmit only corresponding sensory effect data applied to the media data.

The method for generating sensory media according to the present invention further includes generating sensory media by packaging the generated sensory effect metadata with media and transmitting the generated sensory media. A provider may generate sensory effect metadata for media, generate sensory media by combining or packaging the generated sensory effect metadata with media, and transmit the generated sensory media to the RoSE engine. The sensory media may be formed of files in a sensory media format for representing sensory effects. The sensory media format may be a file format to be defined as a standard for representing sensory effects.

In the method for generating sensory media according to the present embodiment, the sensory effect metadata includes sensory effect description information that describes sensory effects. The sensory effect metadata further includes general information about generation of metadata. The sensory effect description information includes media location information that shows locations in media where the sensory effects are applied to. The sensory effect description information further includes sensory effect segment information about segments of media. The sensory effect segment information may include effect list information about sensory effects to be applied to segments in media, effect variable information and segment location information representing locations where sensory effects are applied to. The effect variable information may include sensory effect fragment information containing at least one of sensory effect variables that are applied at the same time.

FIG. 4 is a diagram illustrating a sensory media generator in accordance with an embodiment of the present invention.

Referring to FIG. 4, the sensory media generator 402 includes an input unit 404 for receiving sensory effect information about sensory effects applied to media, and a sensory effect metadata generating unit 406 for generating sensory effect metadata including sensory effect information. The sensory effect metadata includes sensory effect description information that describes sensory effects. The sensory effect description information includes media location information that represents locations in media where sensory effects are applied to. The sensory media generator 402 further includes a transmitting unit 410 for transmitting sensory effect metadata to a RoSE engine. Here, the media may be input through the input unit 404 and transmitted to the RoSE engine or a media player through the transmitting unit 410. Alternatively, the media may be transmitted to the RoSE engine or the media player through an additional path without passing through the input unit 404.

Meanwhile, the sensory media generator 402 may further include a sensory media generating unit 408 for generating sensory media by packaging the generated sensory effect metadata with media. The transmitting unit 410 may transmit the sensory media to the RoSE engine. When the sensory media is generated, the input unit 404 receives the media. The sensory media generating unit 408 generates sensory media by combining or packaging the input media from the input unit 404 with the sensory effect metadata generated from the sensory effect metadata generating unit 406.

The sensory effect metadata includes sensory effect description information that describes sensory effects. The sensory effect metadata may further include general information having information about generation of metadata. The sensory effect description information may include media location information that shows locations in media where sensory effects are applied to. The sensory effect description information may further include sensory effect segment information about segments of media. The sensory effect segment information may include effect list information about sensory effects applied to segments of media, effect variable information, and segment location information that shows locations in segments where sensory effects are applied to. The effect variable information includes sensory effect fragment information. The sensory effect fragment information includes at least one of sensory effect variables that are applied at the same time.

### <Method and Apparatus for Representing Sensory Effects>

Hereinafter, a method and apparatus for representing sensory effects in accordance with an embodiment of the present invention will be described in detail.

The method for representing sensory effects according to the present embodiment includes receiving sensory effect metadata including sensory effect information about sensory effects applied to media, obtaining the sensory effect information by analyzing sensory effect metadata; and generating sensory device command metadata to control sensory devices corresponding to the sensory effect information. The method for representing sensory effects according to the present embodiment further includes transmitting the generated sensory effect command metadata to sensory devices. The sensory device command metadata includes sensory device command description information for controlling sensory devices.

The method for representing sensory effects according to the present embodiment further includes receiving sensory device capability metadata. The receiving sensory device capability metadata may further include referring to capability information included in the sensory device capability metadata.

The method for representing sensory effects according to the present embodiment may further include receiving user sensory preference metadata having preference information about predetermined sensory effects. The generating sensory device command metadata may further include referring to the preference information included in user sensory preference metadata.

In the method for representing sensory effects according to the present embodiment, the sensory device command description information included in the sensory device command metadata may include device command general information that includes information about whether a switch of a sensory device is turned on or off, about a location to setup, and about a direction to setup. Further, the sensory device command description information may include device command detail information. The device command detail information includes detailed operation commands for sensory devices.

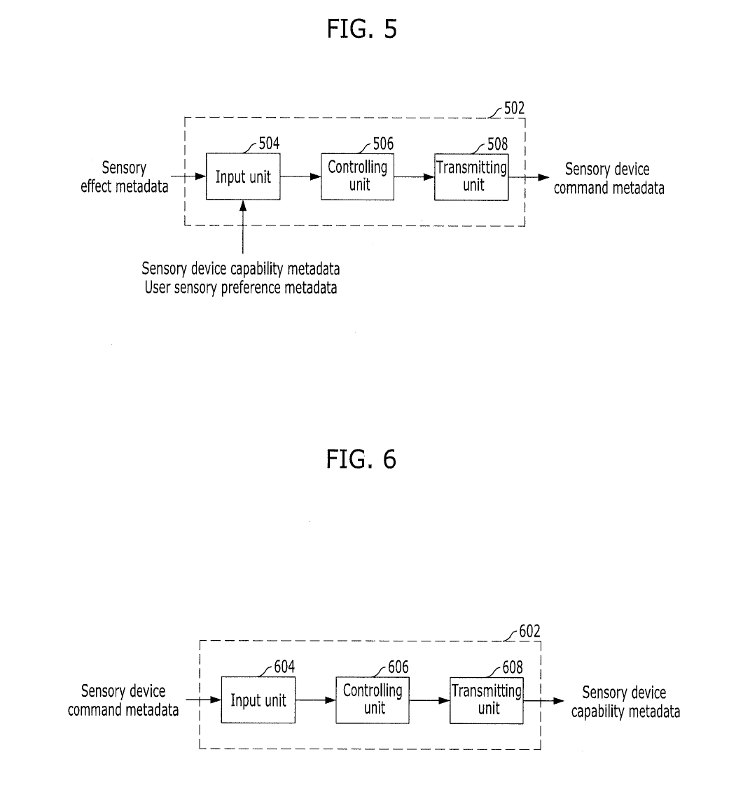

FIG. 5 is a block diagram illustrating an apparatus for representing sensory effects, which is referred to as a representation of sensory effects (RoSE) engine, in accordance with an embodiment of the present invention.

Referring to FIG. 5, the RoSE engine 502 according to the present embodiment includes an input unit 504 for receiving sensory effect metadata having sensory effect information about sensory effects applied to media, and a controlling unit 506 for obtaining sensory effect information by analyzing the received sensory effect metadata and generating sensory effect command metadata to control sensory devices corresponding to the sensory effect information. The sensory device command metadata includes sensory device command description information to control sensory devices. The RoSE engine 502 may further include a transmitting unit 508 for transmitting the generated sensory device command metadata to sensory devices.

The input unit 504 may receive sensory device capability metadata that include capability information about capabilities of sensory devices. The controlling unit 506 may refer to the capability information included in the sensory device capability metadata to generate sensory device command metadata.

The input unit 504 may receive user sensory preference metadata that includes preference information about preferences of predetermined sensory effects. The controlling unit 506 may refer to the preference information included in the user sensory preference metadata to generate the sensory device command metadata.

The sensory device command description information in the sensory device command metadata may include device command general information that includes information about whether a switch of a sensory device is turned on or off, about a location to setup, and about a direction to setup. The sensory device command description information may include device control detail information including detailed operation commands for each sensory device.

### <Method and Apparatus for Providing Sensory Device Capability Information>

Hereinafter, a method and apparatus for providing sensory device capability information in accordance with an embodiment of the present invention will be described in detail.

The method for providing sensory device capability information according to the present embodiment includes obtaining capability information about sensory devices; and generating sensory device capability metadata including the capability information. The sensory device capability metadata includes device capability information that describes capability information. The method for providing sensory device capability information according to the present embodiment may further include transmitting the generated sensory device capability metadata to a RoSE engine.

Meanwhile, the method for providing sensory device capability information according to the present embodiment may further include receiving sensory device command metadata from the RoSE engine and realizing sensory effects using the sensory device command metadata. The RoSE engine generates the sensory effect device command metadata by referring to the sensory device capability metadata.

In the method for providing sensory device capability information according to the present embodiment, the device capability information in the sensory device capability metadata may include device capability common information that include information about locations and directions of sensory devices. The device capability information includes device capability detail information that includes information about detailed capabilities of sensory devices.

FIG. 6 is block diagram illustrating an apparatus for providing sensory device capability information in accordance with an embodiment of the present invention.

The apparatus 602 for providing sensory device capability information may be a device having the same function of a sensory device or may be a sensory device itself. The apparatus 602 may be a stand-alone device independent from a sensory device.

As shown in FIG. 6, the apparatus for providing sensory device capability metadata includes a controlling unit 606 for obtaining capability information about capabilities of sensory devices and generating the sensory device capability metadata including capability information. Here, the sensory device capability metadata includes device capability information that describes capability information. The apparatus for providing sensory device capability information according to the present embodiment further include a transmitting unit 608 for transmitting the generated sensory device capability metadata to the RoSE engine.

The apparatus 602 for providing sensory device capability information may further include an input unit 604 for receiving sensory device command metadata from the RoSE engine. The RoSE engine refers to the sensory device capability metadata to generate the sensory device command metadata. Here, the controlling unit 606 realizes sensory effects using the received sensory device control metadata.

Here, the device capability information included in the sensory device capability metadata may include device capability common information that includes information about locations and directions of sensory devices. The device capability information may include device capability detail information including information about detailed capabilities of sensory devices.

### <Method and Apparatus for Providing User Preference Information>

Hereinafter, a method and apparatus for providing user preference information in accordance with an embodiment of the present invention will be described.

The method for providing user preference information according to the present embodiment includes receiving preference information about predetermined sensory effects from a user, generating user sensory preference metadata including the received preference information. The user sensory preference metadata includes personal preference information that describes preference information. The method for providing user sensory preference metadata according to the present embodiment further includes transmitting the user sensory preference metadata to the RoSE engine.

The method for providing user sensory preference metadata according to the present embodiment may further include receiving sensory device command metadata from a RoSE engine and realizing sensory effects using sensory device command metadata. Here, the RoSE engine refers to the received user sensory preference metadata to generate the sensory device command metadata.

In the method for providing user sensory preference metadata according to the present embodiment, the preference information may include personal information for identifying a plurality of users and preference description information that describes sensory effect preference information of each user. The preference description information may include effect preference information including detailed parameters for at least one of sensory effects.

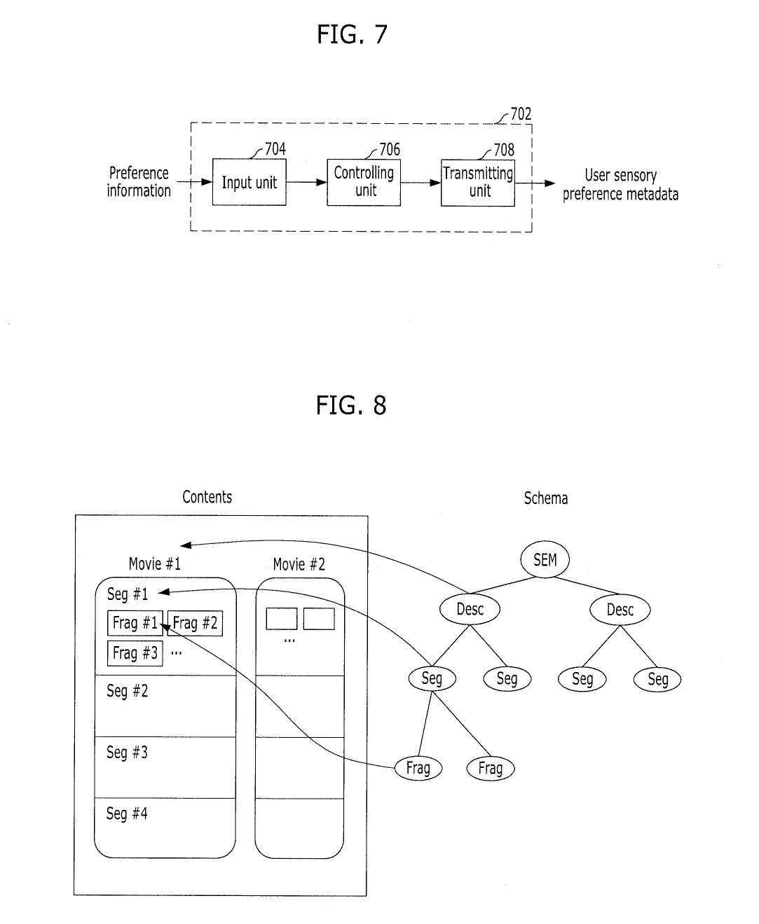

FIG. 7 is a block diagram illustrating an apparatus for providing user sensory preference information in accordance with an embodiment of the present invention.

The apparatus 702 for providing user sensory preference information according to the present embodiment may be a device having the same function of a sensory device or a sensory device itself. Also, the apparatus 702 may be a stand-alone device independent from the sensory device.

As shown in FIG. 7, the apparatus 702 for providing user sensory preference information according to the present embodiment includes an input unit 704 for receiving preference information about predetermined sensory effects from a user and a controlling unit 706 for generating user sensory preference metadata including the received preference information. The user sensory preference metadata includes personal preference information that describes the preference information. The apparatus 702 for providing user sensory preference information according to the present embodiment may further include a transmitting unit 708 for transmitting the generated user sensory preference metadata to the RoSE engine.

The input unit 704 may receive sensory device command metadata from the RoSE engine. The RoSE engine refers to the user sensory preference metadata to generate the sensory device command metadata. The controlling unit 706 may realize sensory effects using the received sensory device command metadata.

The personal preference information included in the user sensory preference metadata includes personal information for identifying each of users and preference description information that describes sensory effect preference of each user. The preference description information may further include effect preference information including detailed parameters about at least one of sensory effects.

### <Sensory Effect Metadata>

Hereinafter, sensory effect metadata according to an embodiment of the present invention will be described in detail.

In order to define sensory effect metadata schema according to the present embodiment, following elements are considered to design the sensory effect metadata schema according to the present embodiment. The first design element is that the sensory effect metadata schema according to the present embodiment is designed to provide various levels of fragmentations to satisfy requirements of metadata. The highest division level is Description. The Description denotes independent video (or audio) tracks in a contents file. The second division level is a segment. The segment denotes temporal parts of one video (audio) track. The lowest division level is fragment. The fragment may include at least one of effect variables that share a time unit. In FIG. 8, Desc stands for description, Seg denotes segment, and Frag represents fragment.

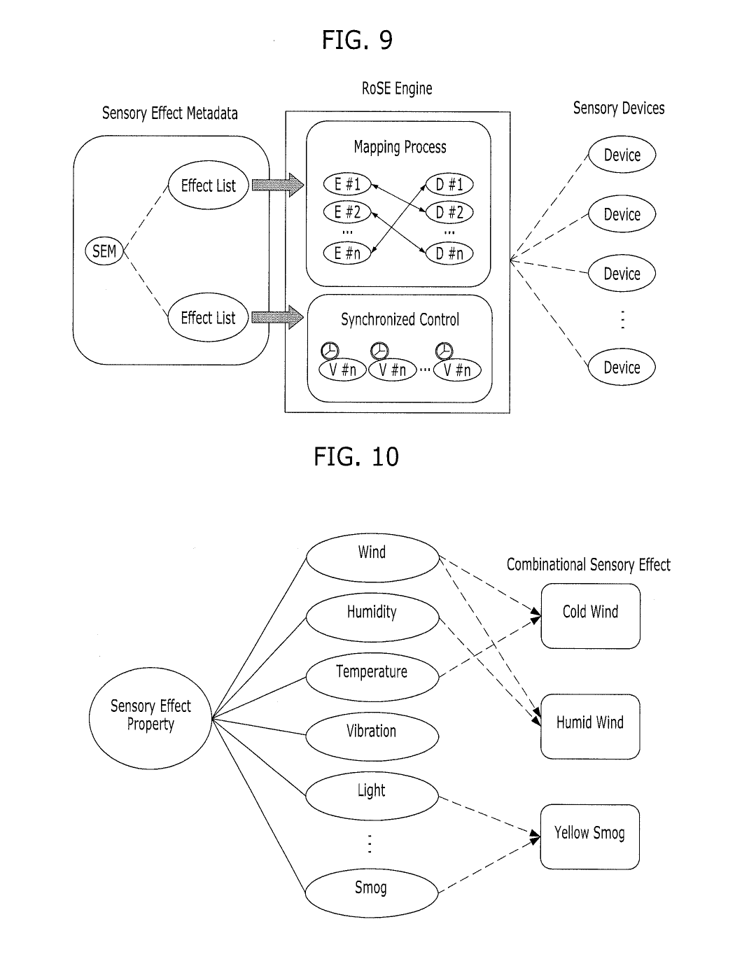

The second design element is that the sensory effect metadata according to the present embodiment is designed to include two main parts: an effect list and effect variables. The effect list includes properties of sensory effects applied to contents. By analyzing the effect list, the RoSE engine can match each of sensory effects to corresponding sensory devices in a user environment and can initialize the sensory devices before processing media scenes. The effect variables include control variables for sensory effects that are synchronized with a media stream. FIG. 9 shows a procedure of processing sensory effect metadata.

The division of the sensory effect metadata into two main parts makes it easier to divide the sensory effect metadata for transmission. The effect list may be transmitted prior to a media stream or may be regularly transmitted to prepare channel switching. The effect variables also can be easily divided and can be transmitted in a unit of time slide.

The third design element is the schema structure according to the present embodiment is designed to provide combinational sensory effect. For example, a sensory effect of humid wind is a combination of sensory effects wind and humidity. Further, a sensory effect of yellow smog is a combination of sensory effects light and smog. A user can make any sensory effects by combining properties defined in the schema according to the present embodiment. FIG. 10 shows a procedure of combining sensory effects.

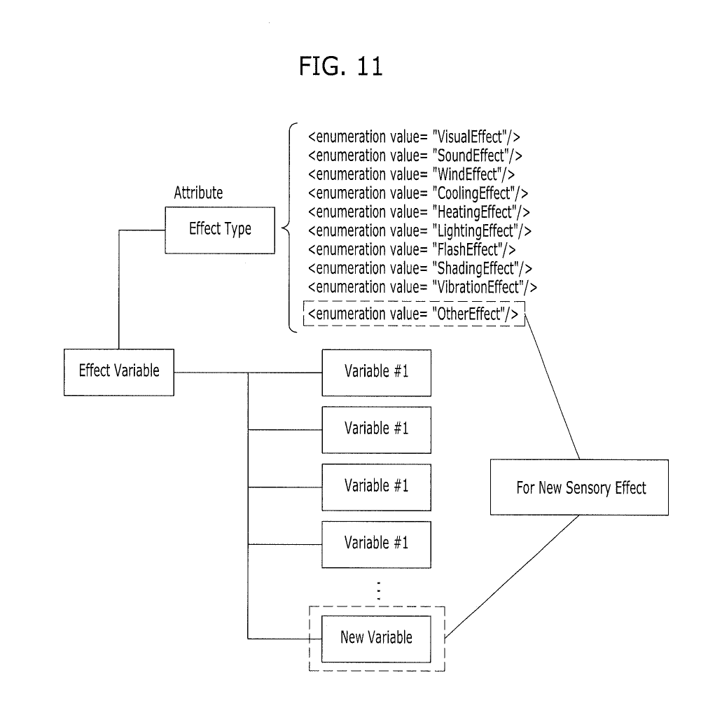

The last design element is expandability. The schema according to the present embodiment may not be sufficient to cover all of sensory effects existing today and in future. Therefore, the scheme according to the present embodiment is designed to expand without significantly change a structure thereof. FIG. 11 is a diagram illustrating a structure of effect variable for describing expandability of sensory effect metadata in accordance with an embodiment of the present invention.

FIG. 11 is a diagram illustrating a structure of effect variables for describing the expandability of sensory effect metadata in accordance with an embodiment of the present invention. If it is necessary to define a new type of sensory effect, sensory effect metadata according to the present embodiment can be expanded by adding enumeration variables and new elements for new sensory effects.

The sensory effect metadata according to the present embodiment may be combined with a media related technology such as MPEG-7 and a network related technology such as LonWorks. As the network related technology such as LonWorks, Standard Network Variable Type (SNVTs) may be used. In this case, a namespace prefix may be used to identify a metadata type. A namespace of the sensory effect metadata according to the present embodiment is defined as “urn:rose:ver1:represent:sensoryeffectmetadata:2008:07” The prefixes for corresponding predetermined namespaces are used for clarification. Table 1 shows prefixes and corresponding namespaces.

TABLE 1

| Prefix | Corresponding namespace |
|---|---|
| SEM | urn:rose:ver1:represent:sensoryeffectmetadata:2008-07 |
| SNVT | urn:SNVT:ver1:Represent:VariableList:2007:09 |
| Mpeg7 | urn:mpeg:mpeg7:schema:2001 |

Hereinafter, definitions and semantics of sensory effect metadata according to the present embodiment will be described in detail.

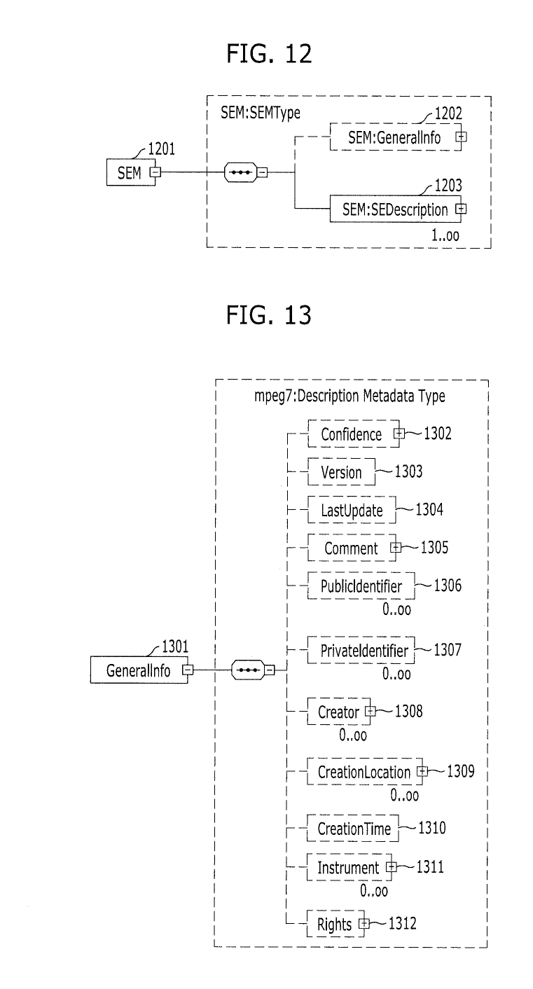

FIG. 12 is a diagram illustrating sensory effect metadata in accordance with an embodiment of the present invention.

Referring to FIG. 12, the sensory effect metadata SEM 1201 includes sensory effect description information (SEDescription) 1203. The sensory effect metadata SEM 1201 may further include general information (GeneralInfo) 1202. Table 2 shows such elements of the sensory effect metadata SEM in detail.

TABLE 2

| Name | Definition |
|---|---|
| GeneralInfo | An element containing the information on the Metadata |
| | creation |
| SEDescription | An element containing the Sensory Effect description. |
| | It is possible to describe a description for each |
| | movie track in a file. |

The general information (GeneralInfo) 1202 includes information related to generation of sensory effect metadata (SEM) 1201. The sensory effect description information (SEDescription) 1203 describes sensory effects. Further, the sensory effect description information 1203 may include information that describes sensory effects for each movie track in a file.

A schema for the sensory effect metadata 1201 according to the present embodiment shown in FIG. 12 is exemplary described as follows.

```
<element name=“SEM” type=“SEM:SEMType”/>
  <complexType name=“SEMType”>
    <sequence>
      <element  name=“GeneralInfo”
      type=“mpeg7:DescriptionMetadataType” minOccurs=“0”/>
      <element  name=“SEDescription”
      type=“SEM:SEDescriptionType” maxOccurs=“unbounded”/>
    </sequence>
</complexType>
```

FIG. 13 is a diagram illustrating general information (GeneralInfo) included in the sensory effect metadata in accordance with an embodiment of the present invention.

The general information (GeneralInfo) includes information related to the generation of sensory effect metadata. Referring to FIG. 12, the general information (GeneralInfo) 1301 includes following elements: Confidence 1302, Version 1303, LastUpdate 1304, Comment 1305, PublicIdentifier 1306, PrivateIdentifier 1307, Creator 1308, CreationLocation 1309, CreationTime 1310, Instrument 1311, and Rights 1312.

The general information (GeneralInfo) 1301 may include information about the generation of general metadata. For example, the general information (GeneralInfo) 1301 may include information about a version, a last update date, a creator, a creation date, a creation nation, and a copyright. A type of the general information (GeneralInfo) 1301 may be referred by mpeg7:DescriptionMetadataType of MPEG7.

A schema for the general information (GeneralInfo) 1301 is exemplary described as follows.

```
<complexType name=“DescriptionMetadataType”>
  <complexContent>
    <extension base=“mpeg7:HeaderType”>
      <sequence>
          <element  name=“Confidence”
          type=“mpeg7:zeroToOneType” minOccurs=“0”/>
          <element  name=“Version”  type=“string”
          minOccurs=“0”/>
          <element  name=“LastUpdate”
          type=“mpeg7:timePointType” minOccurs=“0”/>
          <element  name=“Comment”
          type=“mpeg7:TextAnnotationType” minOccurs=“0”/>
          <element  name=“PublicIdentifier”
          type=“mpeg7:UniqueIDType”  minOccurs=“0”
          maxOccurs=“unbounded”/>
          <element  name=“PrivateIdentifier”  type=“string”
          minOccurs=“0” maxOccurs=“unbounded”/>
          <element  name=“Creator”  type=“mpeg7:CreatorType”
          minOccurs=“0” maxOccurs=“unbounded”/>
          <element  name=“CreationLocation”
          type=“mpeg7:PlaceType” minOccurs=“0”/>
          <element  name=“CreationTime”
          type=“mpeg7:timePointType” minOccurs=“0”/>
          <element  name=“Instrument”
          type=“mpeg7:CreationToolType”  minOccurs=“0”
          maxOccurs=“unbounded”/>
          <element name=“Rights”  type=“mpeg7:RightsType”
          minOccurs=“0”/>
      </sequence>
    </extension>
  </complexContent>
</complexType>
```

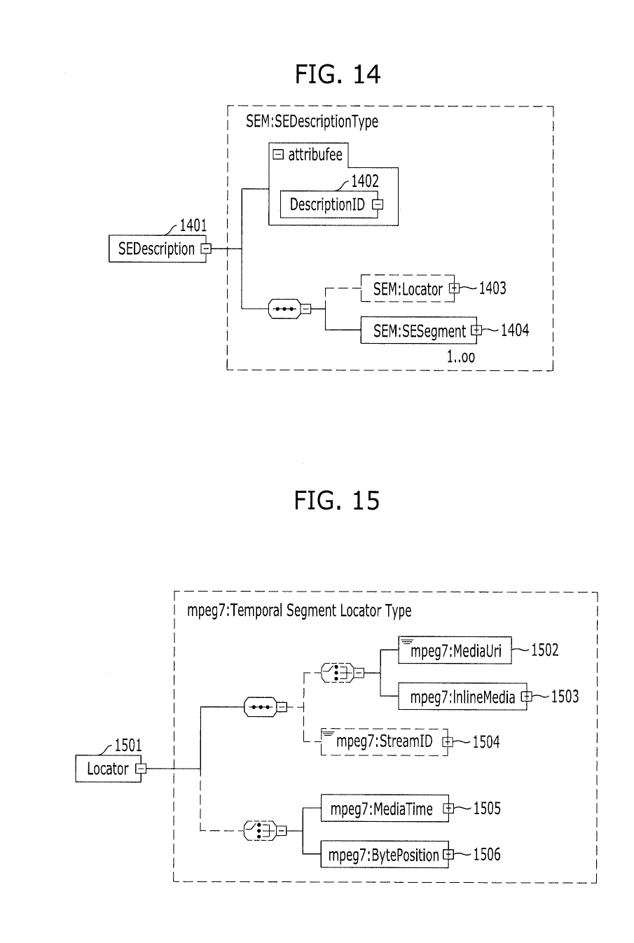

FIG. 14 is a diagram illustrating sensory effect description information (SEDescription) included in sensory effect metadata in accordance with an embodiment of the present invention.

In the present embodiment, the sensory effect description information (SEDescription) describes sensory effects for each of tracks if a file includes a plurality of video and audio tracks. Referring to FIG. 14, the sensory effect description (SEDescrition) 1401 may include following elements: DescriptionID 1402, Locator 1403, and at least one SESegment 1404. Table 3 shows these elements in detail.

TABLE 3

| Name | Definition |
|---|---|
| DescriptionID | An attribute containing ID of the description |
| Locator | An element describing location of media data. The |
| | type of this element is defined in |
| | mpeg7:TemporalSegmentLocatorType |
| SESegment | An element containing Segment of Sensory Effect |
| | description. Segment means DVD chapter for example. |

DescriptionID 1402 is an attribute including an identification ID of sensory effect description information (SEDescription) 1401. Locator 1403 is an element describing a location of media data. A type of Locator 1403 is defined in mepg7:TemporalSegmentLocatorType. SESegment 1404 includes sensory effect description information about segment of media. For example, a segment is a chapter in DVD.

A schema for the sensory effect description information SEDescription (1401) of FIG. 14 is exemplary described as follows.

```
<element name=“SEDescription” type=“SEM:SEDescriptionType”/>
  <complexType name=“SEDescriptionType”>
    <sequence>
        <element  name=“Locator”
        type=“mpeg7:TemporalSegmentLocatorType”
        minOccurs=“0”/>
        <element  name=“SESegment”  type=
        “SEM:SESegmentType” maxOccurs=“unbounded”/>
      </sequence>
        <attribute  name=“DescriptionID”  type=“ID”
        use=“required”/>
      </complexType>
```

FIG. 15 is a diagram illustrating media location information (Locator) included in the sensory effect metadata in accordance with an embodiment of the present invention.

Locator specifies a location of media data where sensory effect description information is provided to. A type of the media location information (Locator) is defined in mpeg7:TemporalSegmentLocatorType. Referring to FIG. 15, Locator 1501 includes following elements: MediaUri 1502, InlineMedia 1503, StreamID 1504, MediaTime 1505, and BytePosition 1506.

A schema for Locator 1501 of FIG. 15 is exemplary shown as follows.

```
<element  name=“Locator”
type=“mpeg7:TemporalSegmentLocatorType”/>
  <complexType name=“TemporalSegmentLocatorType”>
    <complexContent>
      <extension base=“mpeg7:MediaLocatorType”>
          <choice minOccurs=“0”>
            <element  name=“MediaTime”
            type=“mpeg7:MediaTimeType”/>
            <element name=“BytePosition”>
        <complexType>
            <attribute  name=“offset”  type=“nonNegativeInteger”
            use=“required”/>
            <attribute  name=“length”  type=“positiveInteger”
            use=“optional”/>
      </complexType>
    </element>
  </choice>
  </extension>
  </complexContent>
</complexType>
```

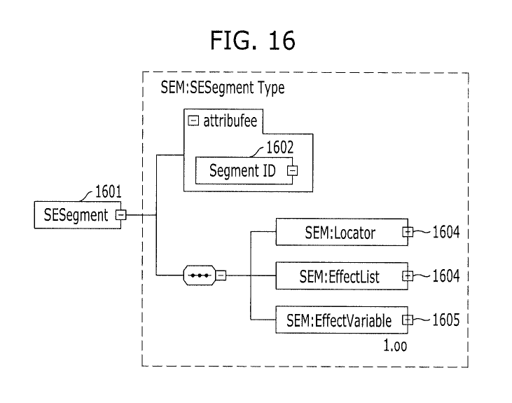

FIG. 16 is a diagram illustrating sensory effect segment information (SESegment) included in sensory effect metadata in accordance with an embodiment of the present invention.

Like segments of media data, sensory effect description information may be also divided into different segments. The sensory effect segment information (SESegment) includes sensory effect description information about segments such as DVD chapters. Referring to FIG. 16, the sensory effect segment information (SESegment) 1601 includes following elements: a segment identifier (SegmentID) 1602, segment location information (Locator) 1603, effect list information (EffectList) 1604, and at least one effect variable (EffectVariable) 1605. Table 4 shows the elements of the sensory effect segment information (SESegment) in detail.

TABLE 4

| Name | Definition |
|---|---|
| SegmentID | An attribute containing ID of the segment |
| Locator | An element describing segment location of media data. |
| | The type of this element is defined in |
| | mpeg7:TemporalSegmentLocatorType |
| EffectList | An element contains a list of Sensory Effect and |
| | the property of each Sensory Effect applied to the |
| | contents |
| EffectVariable | An element contains a set of Sensory Effect control |
| | variables and time information for synchronization |
| | with media scene |

The segment identifier (SegmentID) 1602 is a property including an identifier of segment. The segment location information (Locator) 1603 is an element describing segment location information of media data. A type of the segment location information (Locator) 1603 is defined in mpeg7:TemporalSegmentLocatorType. The effect list information (EffectList) 1604 includes properties of sensory effects applied to sensory effect list and contents. The effect variable information (EffectVariable) 1605 includes time information about synchronization of a set of sensory effect variables with media scenes.

A schema for the sensory effect segment information (SESegment) of FIG. 16 is exemplary shown as follows.

```
<complexType name=“SESegmentType”>
  <sequence>
    <element  name=“Locator”
    type=“mpeg7:TemporalSegmentLocatorType”/>
    <element name=“EffectList” type=“SEM:EffectList”/>
    <element  name=“EffectVariable”
    type=“SEM:EffectVariableType”  maxOccurs=“unbounded”/>
  </sequence>
    <attribute name=“SegmentID” type=“ID” use=“required”/>
</complexType>
```

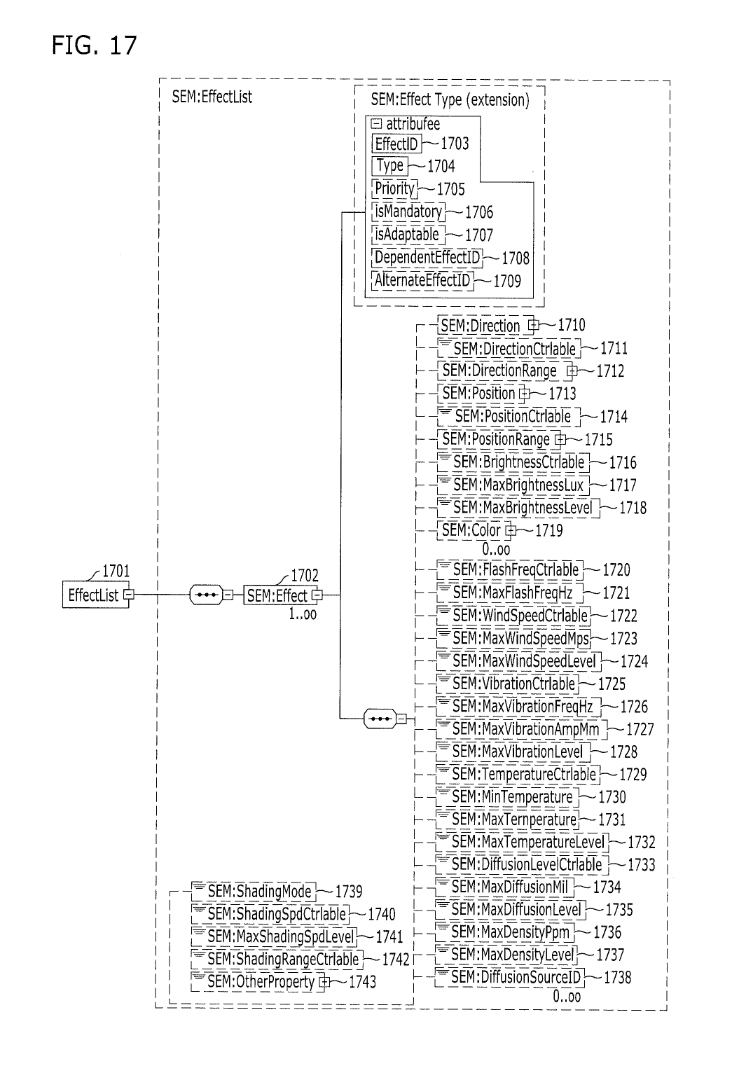

FIG. 17 is a diagram illustrating effect list information (EffectList) included in sensory effect metadata in accordance with an embodiment of the present invention.

The effect list information (EffectList) includes information about all of sensory effects applied to contents. The effect identifier (EffectID) and type information (Type) confirm each of sensory effects (effect list in a schema) and are defined in every of sensory effects for informing a category of a sensory effect. Such effect elements include a set of property elements for describing sensory effect capabilities. The RoSE engine can match each of sensory effects with proper sensory devices through the set of property elements.

Referring to FIG. 17, the effect list information (EffectList) 1701 includes effect information (Effect) 1702. The effect information (Effect) 1702 includes following elements: EffectID 1703, Type 1704, Priority 1705, isMandatory 1706, isAdaptable 1707, DependentEffectID 1708, and AlternateEffectID 1709.

The effect information (Effect) 1702 also includes following elements: Direction 1710, DirectionCtrlable 1711, DirectionRange 1712, Position 1713, PositionCtrlable 1714, PositionRange 1715, BrightnessCtrlable 1716, MaxBrightnessLux 1717, MaxBrightnessLevel 1718, Color 1719, FlashFreqCtrlble 1720, MaxFlashFreqHz 1721, WindSpeedCtrlble 1722, MaxWindSpeedMps 1723, MaxWindSpeedLevel 1724, VibrationCtrlble 1725, MaxVibrationFreqHz 1726, MaxVibrationAmpMm 1727, MaxVibrationLevel 1728, TemperatureCtrlble 1729, MinTemperature 1730, MaxTemperature 1731, MaxTemperatureLevel 1732, DiffusionLevelCtrlable 1733, MaxDiffusionMil 1734, MaxDiffusionLevel 1735, MaxDiffusionPpm 1736, MaxDensityLevel 1737, DiffusionSourceID 1738, ShadingMode 1739, ShadingSpdCtrlable 1740, MaxShadingSpdCtrlable 1741, ShadingRangeCtrlable 1742, and OtherProperty 1743. Table 5 shows these elements of the effect information (Effect) 1702 in detail.

TABLE 5

| Name | Definition | |
|---|---|---|
| EffectID | An attribute containing ID of individual Sensory Effect. | |
| | An attribute containing the enumeration set of SensoryEffect type. | |
| Type | Enumeration Value | Description |
| | “VisualEffect” | Sensory Effect for visual display such as |
| | | monitor, TV, wall, screen, etc. |
| | “SoundEffect” | Sensory Effect for sound such as speaker, |
| | | music instrument, bell, etc. |
| | “WindEffect' | Sensory Effect for wind such as fan, wind |
| | | injector, etc. |
| | “CoolingEffect” | Sensory Effect for temperature such as air |
| | | conditioner. |
| | “HeatingEffect” | Sensory Effect for temperature such as heater, |
| | | fire, etc |
| | “LightingEffect' | Sensory Effect for light bulb, dimmer, color |
| | | LED, flash, etc. |
| | “FlashEffect” | Sensory Effect for flash |
| | “ShadingEffect” | Sensory Effect for curtain open/close, roll |
| | | screen up/down, door open/close, etc. |
| | “VibrationEffect” | Sensory Effect for vibration such as trembling |
| | | chair, joystick, tickler etc. |
| | “DiffusionEffect” | Sensory Effect for scent, smog, spray, water |
| | | fountain, etc. |
| | “OtherEffect” | Sensory Effect which is not defined or |
| | | combination of above effect type |
| Priority | An optional attribute defining priority among the number of Sensory Effects | |
| isMandatory | An optional attribute indicating whether this Sensory Effect must be rendered | |
| isAdaptable | An optional attribute indicating whether this Sensory Effect can be adapted | |
| | accoring to the User Sensory Preference | |
| DependentEffectID | An optional attribute containing ID of the Sensory Effect which current | |
| | Sensory Effect will be dependent on | |
| AlternalteEffectID | An optional attribute containing ID of alternate Sensory Effect which can be | |
| | replace current Sensory Effect | |
| Direction | An optional element describing the direction of Sensory Effect. The type of | |
| | this element is SEM:DirectionType. | |
| | 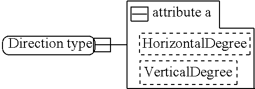 | |
| | Direction is defind by the combination values of HorizontalDegree and | |
| | VerticalDegree. | |
| DirectionCtrlable | An optional element indicating whether Sensory Effect can control direction. | |
| | The type is Boolean. | |
| DirectionRange | An optional element defining the range of direction that Sensory Effect can | |
| | change. The range is described by minimum and maximum value of horizontal | |
| | and vertical angle. The type of this element is SEM:DirectionRangeType. | |
| | 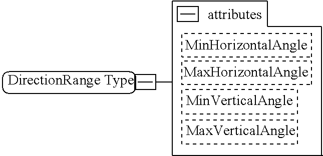 | |
| Position | An optional element describing the position of Sensory Effect. The type of this | |
| | element is SEM:PositionType. | |
| | 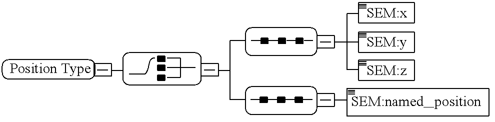 | |
| | Position can be defined in two ways based on user position. First, it can be | |
| | defined by X, Y, Z values. Second, it can be defined by named_position which | |
| | has the enumeration set of predefined position. | |
| | 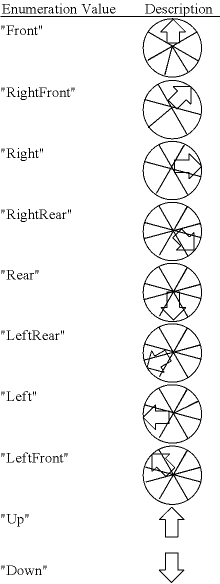 | |
| PositionCtrlable | An optional element indicating whether Sensory Effect can control position. | |
| | The type is Boolean. | |
| PositionRange | An optional element definging the range of the position that Sensory Effect can | |
| | move. The range is described by maximum and minimum value of x, y, and z | |
| | axis. The type of this element is SEM:PositionRangeType. | |
| | 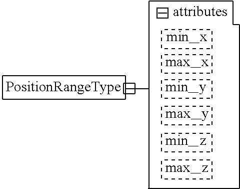 | |
| BrightnessControllable | An optional element indicating whether Sensory Effect can control brightness. | |
| | The type is Boolean. | |
| MaxBrightnessLux | An optional element describing maximum brightness that Sensory Effect can | |
| | be adjusted in LUX. The type is SEM:LuxType. | |
| MaxBrightnessLevel | An optional element describing maximum brightness that Sensory Effect can | |
| | be adjusted in level. The type is SEM:LevelType. | |
| Color | An optional element describing the color of the Sensory Effect. In case that the | |
| | Sensory Effect has mono color such as light bulb, only one color will be | |
| | defined. In other case that the Sensory Effect has multi color such as LED | |
| | light, more than one color will be defined. The type of this element is | |
| | Color Type. | |
| | 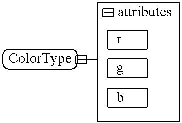 | |
| | Color is defined by the combination values of r, g, b. | |
| FlashFreqCtrlable | An optional element indicating whether Sensory Effect can control flickering | |
| | frequency. The type is Boolean. | |
| MaxFlashFreqHz | An optional element defining maximum flickering frequency that Sensory | |
| | Effect can be adjusted in Hz. The type is SEM:FreqType. | |
| WindSpeedCtrlable | An optional element indicating whether Sensory Effect can control wind | |
| | speed. The type is Boolean. | |
| MaxWindSpeedMps | An optional element defining maximum wing speed that Sensory Effect can be | |
| | adjusted in Mps (Meter per second). The type is SEM:WinSpeedType. | |
| MaxWindSpeedLevel | An optional element defining maximum wind speed that Sensory Effect can | |
| | adjust in level. The type is SEM:LevelType. | |
| VibrationCtrlable | An optional element indicating whether Sensory Effect can control vibration | |
| | frequency. The type is Boolean. | |
| MaxVibrationFreqHz | An optional element defining maximum vibration frequency that Sensory | |
| | Effect can be adjusted in Hz. The type is SEM:FreqType. | |
| MaxVibrationAmpMm | An optional element defining maximum vibration amplitude that Sensory | |
| | Effect can be adjusted in Millimeter. The type is unsigned integer. | |
| MaxVibrationLevel | An optional element defining max vibration intensity level that Sensory Effect | |
| | can be adjusted. The type is SEM:LevelType. | |
| TemperatureCtrlable | An optional element indicating whether Sensory Effect can control | |
| | temperature in Celsius. The type is Boolean. | |
| MinTemperature | An optional element defining minimum temperature that Sensory Effect can be | |
| | adjusted in Celsius | |
| MaxTemperature | An optional element defining maximum temperature that Sensory Effect can | |
| | be adjusted in Celsius | |
| MaxTemperature | An optional element defining maximum temperature controlling level that | |
| Level | Sensory Effect can adjust | |
| DiffusionLevel | An optional element indicating whether Sensory Effect can control diffusion | |
| Ctrlable | level | |
| MaxDiffusionMil | An optional element defining maximum diffusion quantity that Sensory Effect | |
| | can be adjusted in Milligram | |
| MaxDiffusionLevel | An optional element defining maximum diffusion level that Sensory Effect can | |
| | be adjusted | |
| MaxDensityPpm | An optional element defining maximum density that Sensory Effect can be | |
| | adjusted in Ppm | |
| MaxDensityLevel | An optional element defining maximum density level that Sensory Effect can | |
| | be adjusted | |
| DiffusionSourceID | An optional element defining source ID that Sensory Effect contains. Sensory | |
| | Effect may have multiple sources | |
| Shading | An optional element having enumeration set of the shading mode of Sensory | |
| | Effect | |
| | EnumerationValue | Description |
| | “SideOpen” | Curtain type |
| | “RollOpen” | Roll screen type |
| | “PullOpen” | Pull door type |
| | “PushOpen” | Push door type |

| | |
|---|---|
| ShadingSpdCtrlable | An optional element indicating whether Sensory Effect can control shading |
| | speed |
| MaxShadingSpdLevel | An optional element defining maximum shading speed level that Sensory |
| | Effect can be adjusted |
| ShadingRangeCtrlable | An optional element indicating whether Sensory Effect can control shading |
| | range |
| OtherProperty | An optional element for expandable Sensory Effect property |
| | 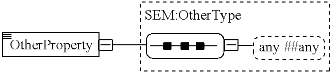 |

EffectID 1703 is an attribute having identifiers (ID) of individual sensory effects. Type 1704 is an attribute having an enumeration set of sensory effect types. As shown in Table 5, Type 1704 includes enuerationv values such as VisualEffect, SoundEffect, WindEffect, CoolingEffect, HeatingEfgfect, LightingEffect, FlashEffect, ShdingEffect, VibrationEffect, DiffusionEffect, and OtherEffect. VisualEffect denotes sensory effects for visual display such as a monitor, a TV, or a wall screen. SoundEffect represents sensory effects for sound such as a speaker, munical instrument, and bell. WindEffect indicates sensory effects for wind such as a fan, and a wind injector. CoolingEffect denotes sensory effects for cooling temperature such as an air conditioner. HeatingEfgfect represents sensory effects related to temperature such as a heater or a fire, LightingEffe denotes sensory effects for lighting such as light bulbs, dimmers, color LEDs, and a flash. FlashEffect represents sensory effects related to flash. ShdingEffect denotes sensory effects related to shading that may be made by opening or closing a curtain, rolling up or down a screen, or opening or closing doors. VibrationEffect denotes sensory effects for vibration such as a trembling chair, a joystick, and a ticker. DiffusionEffect indicates sensory effect for scent, smog, spray, water, and fountain. OtherEffect denotes sensory effects that are not defined or combination of above effect types.

Priorty 1705 is an optional attribute that defines a priority among a plurality of sensory effects. isMandatory 1706 is an optional attribute that indicates whether a corresponding sensory effect must be rendered or not. isAdaptable 1707 is an optional attribute indicating whether a corresponding sensory effect can be adapted according to user sensory preference. DependentEffectID 1708 is an optional attribute that includes an identifier (ID) of a sensory effect that a current sensory effect will be dependent on. AlternateEffectID 1709 is an optional element having an identifier of an alternative sensory effect which can be replaced with a current sensory effect.

Direction 1710 is an optional element that describes a direction of sensory effect. A type of Direction 1710 is DirectionType. As shown in Table 5, Direction 1710 is defined based on combination of a horizontal angle (HorizontalDegree) and a vertical angle (VerticalDegree). DirectionCtrlable 1711 is an optional element that indicates whether a corresponding sensory effect can control a direction. A type of DirectionCtrlable 1711 is Boolean. DirectionRange 1712 is an optional element that defines a range of directions that a corresponding sensory effect can change. DirectionRange 1712 can be defined by a minimum value and a maximum value of a horizontal and vertical ange. As shown in Table 5, a type of DirectionRange 1712 is DirectionRangeType including MinHorizontalAngle, MaxHorizontalAngle, MinVerticalAngle, and MaxVerticalAngle.

Position 1713 is an optional element that described a position of a sensory effect. A type of this element is PositionType. As shown in Table 5, Position 1713 may be defined by two methods based on a user position. As a first method, Position 1713 can be defined based on x, y, z values. As a second method, Position 1713 may be defined as named_position that has an enumartion list of predefined post ions. Table 5 defines enumeration values of named_position and a corresponding position thereof.

PositionCtrlable 1714 is an optional element that indicates whether a sensory effect can control a position of not. A type of this element is Boolean. PositionRange 1715 is an optional ement that defines a range of positions that a sensory effect moves. PositionRange 1715 is defined by maximum values and minium values of x, y, and z axies. A type of this element is PositionRangeType. As shown in Table 5, PositionRangeType includes a x-axis minimum value (min_x), a x-axis maximum value (max_x), a y-axis minium value (min_y), a y-axis maximum value (man_y), a z-axis minimum value (min_z), and a z-axis maximum value (max_z).

BrightnessCtrlable 1716 is an optional element that indicates whether a sensory effect can control brightness or not. A type of this element is Boolean. MaxBrightnessLux 1717 is an optional element that describes the maximum brightness in a Lux unit that can be controlled by a sensory effect. A type of this element is LuxType. MaxBrightnessLevel 1718 is an optional element that can describe the maximum brightness in a unit of level that can be controlled by a sensory effect. A type of this element is LevelType.

Color 1719 is an optional element that describeds a color of a sensory effect. If a sensory effect has a mono color such as a white light bulb, only one color is defined. If a sensory effect has various colors such as a LED light, a plurality of colors may be defined. A type of this element is ColorType. As shown in Table 5, Color 1719 is defined based on combination of r, g, and b values.

FlashFreqCtrlble 1720 is an optional element that indicates whether a sensory effect can control a flickering frequency. A type of this element is Boolean. MaxFlashFreqHz 1721 defines a maximum flickering frequency in a unit of Hz that can be controlled by a sensory effect.

WindSpeedCtrlble 1722 is an optional element that indicates whether a speed of wind can be controlled by a sensory effect or not. A type of this element is Boolean. MaxWindSpeedMps 1723 is an optional element that defines a maximum wind speed in Mps (meter per sound) that can be controlled by a sensory effect. A type thereof is WindSpeedType. MaxWindSpeedLevel 1724 is an optional element defining a maximum wind speed in a unit of level that can be controlled by a sensory effect. A type thereof is LevelType.

VibrationCtrlble 1725 is an optional element that indicates whether a sensory effect can control vibration frequency. A type thereof is boolean. MaxVibrationFreqHz 1726 is an optional element defining a maximum vibration frequency in a unit of Hz that can be controlled by a sensory effect. A type of this element is FreqType. MaxVibrationAmpMm 1727 is an optional element defining maximum vibration amplitude in a unit of millimeter that can be controlled by a sensory effect. A type of this element is unsigned integer. MaxVibrationLevel 1728 is an optional element defining maximum vibration amplitude in a unit of level that can be controlled by a sensory effect.

TemperatureCtrlble 1729 is an optional element that indicates whether a sensory effect can control temperature in a unit of Celsius or not. A type of this element is Boolean. MinTemperature 1730 is an optional element defining a minimum temperature that a sensory effect can control in a unit of Celsius. MaxTemperature 1731 is an optional element defining a maximum temperature that a sensory effect can control in a unit of Celsius. MaxTemperatureLevel 1732 is an optional element defining a maximum temperature in a unit of level that a sensory effect controls.

DiffusionLevelCtrlable 1733 is an optional element that indicates whether a sensory effect can control a diffusion level. MaxDiffusionMil 1734 is an optional element defining maximum diffusion quantity that a sensory effect can adjust in a millimeter unit. MaxDiffusionLevel 1735 is an optional element defining a maximum diffusion level that a sensory effect can adjust. MaxDiffusionPpm 1736 is an optional element that defines a maximum density in a unit of Ppm that a sensory effect can adjust. MaxDensityLevel 1737 is an optional element defining a maximum density level that a sensory effect can adjust. DiffusionSourceID 1738 is an optional element that defines a source identifier (ID) included in a sensory effect. A sensory effect may include a plurality of sources.

ShadingMode 1739 is an optional element that includes an enumeration list of shading modes of a sensory effect. As shown in Table 5, ShadingMode 1739 has enumeration values such as SideOpen for describing a curtain type, RollOpen for describing a roll screen type, Pull door for describing a pull door type, and PushOpen for describing a push door type.

ShadingSpdCtrlable 1740 is an optional element indicating whether a sensory effect can control a speed of shading or not. MaxShadingSpdCtrlable 1741 is an optional element defining a maximum shading level that a sensory effect can control. ShadingRangeCtrlable 1742 is an optional element indicating whether a sensory effect can control a shading range.

OtherProperty 1743 is an optional element for extendable sensory effect property.

A schema for the effect list information (EffectList) of FIG. 17 is exemplary shown as follows.

<element name=“EffectList” type=“SEM:EffectList”/>
<complexType name=“EffectList”>
<sequence>
<element name=“Effect” maxOccurs=“unbounded”>
<complexType>
<complexContent>
<extension base=“SEM:EffectType”>
<sequence>

| | |
|---|---|
| <element name=“Direction” | type=“SEM:DirectionType” |
| minOccurs=“0”/> | |
| <element name=“DirectionCtrlable” | type=“boolean” |
| minOccurs=“0”/> | |
| <element name=“DirectionRange” | |
| type=“SEM:DirectionRangeType” minOccurs=“0”/> | |
| <element name=“Position” | type=“SEM:PositionType” |
| minOccurs=“0”/> | |
| <element name=“PositionCtrlable” | type=“boolean” |
| minOccurs=“0”/> | |
| <element | name=“PositionRange” |
| type=“SEM:PositionRangeType” minOccurs=“0”/> | |
| <element name=“BrightnessCtrlable” | type=“boolean” |
| minOccurs=“0”/> | |
| <element name=“MaxBrightnessLux” | type=“SEM:LuxType” |
| minOccurs=“0”/> | |
| <element name=“MaxBrightnessLevel” | type=“SEM:LevelType” |
| minOccurs=“0”/> | |
| <element name=“Color” | type=“SEM:ColorType” |
| minOccurs=“0” maxOccurs=“unbounded”/> | |
| <element name=“FlashFreqCtrlable” | type=“boolean” |
| minOccurs=“0”/> | |
| <element name=“MaxFlashFreqHz” | type=“SEM:FreqType” |
| minOccurs=“0”/> | |
| <element name=“WindSpeedCtrlable” | type=“boolean” |
| minOccurs=“0”/> | |
| <element name=“MaxWindSpeedMps” | type=“SEM:WindSpeedType” |
| minOccurs=“0”/> | |
| <element name=“MaxWindSpeedLevel” | type=“SEM:LevelType” |
| minOccurs=“0”/> | |
| <element name=“VibrationCtrlable” | type=“boolean” |
| minOccurs=“0”/> | |
| <element name=“MaxVibrationFreqHz” | type=“SEM:FreqType” |
| minOccurs=“0”/> | |
| <element name=“MaxVibrationAmpMm” | type=“unsignedInt” |
| minOccurs=“0”/> | |
| <element name=“MaxVibrationLevel” | type=“SEM:LevelType” |
| minOccurs=“0”/> | |
| <element name=“TemperatureCtrlable” | type=“boolean” |
| minOccurs=“0”/> | |
| <element | name=“MinTemperature” |

type=“SEM:MinTemperatureType” minOccurs=“0”/>

| | |
|---|---|
| <element | name=“MaxTemperature” |

```
    type=“SEM:MaxTemperatureType” minOccurs=“0”/>
    <element name=“MaxTemperatureLevel” type=“SEM:LevelType”
    minOccurs=“0”/>
```

| | |
|---|---|
| <element name=“DiffusionLevelCtrlable” | type=“boolean” |
| minOccurs=“0”/> | |
| <element name=“MaxDiffusionMil” | type=“SEM:DiffusionType” |
| minOccurs=“0”/> | |
| <element name=“MaxDiffusionLevel” | type=“SEM:LevelType” |
| minOccurs=“0”/> | |
| <element name=“MaxDensityPpm” | type=“SEM:DensityType” |
| minOccurs=“0”/> | |
| <element name=“MaxDesityLevel” | type=“SEM:LevelType” |
| minOccurs=“0”/> | |
| <element name=“DiffusionSourceID” | type=“ID” |
| minOccurs=“0” maxOccurs=“unbounded”/> | |
| <element name=“ShadingMode” minOccurs=“0”> | |
| <simpleType> | |
| <restriction base=“string”> | |
| <enumeration value=“SideOpen”/> | |
| <enumeration value=“RollOpen”/> | |
| <enumeration value=“PullOpen”/> | |
| <enumeration value=“PushOpen”/> | |
| </restriction> | |
| </simpleType> | |
| </element> | |
| <element name=“ShadingSpdCtrlable” | type=“boolean” |
| minOccurs=“0”/> | |
| <element name=“MaxShadingSpdLevel” | type=“SEM:LevelType” |
| minOccurs=“0”/> | |
| <element name=“ShadingRangeCtrlable” | type=“boolean” |
| minOccurs=“0”/> | |
| <element name=“OtherProperty” | type=“SEM:OtherType” |
| minOccurs=“0”/> | |
| </sequence> | |
| </extension> | |
| </complexContent> | |
| </complexType> | |
| </element> | |
| </sequence> | |
| </complexType> | |

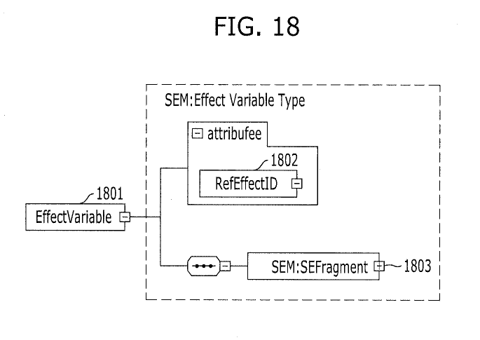

FIG. 18 is a diagram illustrating effect variable information (EffectVariable) included in sensory effect metadata in accordance with an embodiment of the present invention.

The effect variable information (EffectVariable) includes various sensory effect variables for controlling sensory effects. Referring to FIG. 18, the effect variable information (EffectVariable) 1801 includes following elements SEFragment 1803 and RefEffectID 1802. Table 6 describes these elements in detail.

TABLE 6

| Name | Definition |
|---|---|
| RefEffectID | An attribute containing Sensory Effect ID referenced from |
| | EffectID which is defined as attribute of Effect under |
| | EffectList |
| SEFragment | An element containing a set of Sensory Effect variables |
| | which share common time slot (start and duration) |

The RefEffectID 1802 is an attribute containing a sensory effect ID referred from EffectID which is defined as an attribute of Effect under EffectList. The SEFragment 1803 is an element containing a set of sensory effect variables which share common time slot (start and duration).

A schema for the effect variable information (EffectVariable) shown in FIG. 18 is exemplary shown as follows.

<element name=“EffectVariable” type=“SEM:EffectVariableType”/>
<complexType name=“EffectVariableType”>
<sequence>

| | |
|---|---|
| <element | name=“SEFragment” |
| type=“SEM:SEFragmentType” | |
| maxOccurs=“unbounded”/> | |
| </sequence> | |

| | |
|---|---|
| <attribute name=“RefEffectID” | type=“IDREF” |
| use=“required”/> | |
| </complexType> | |

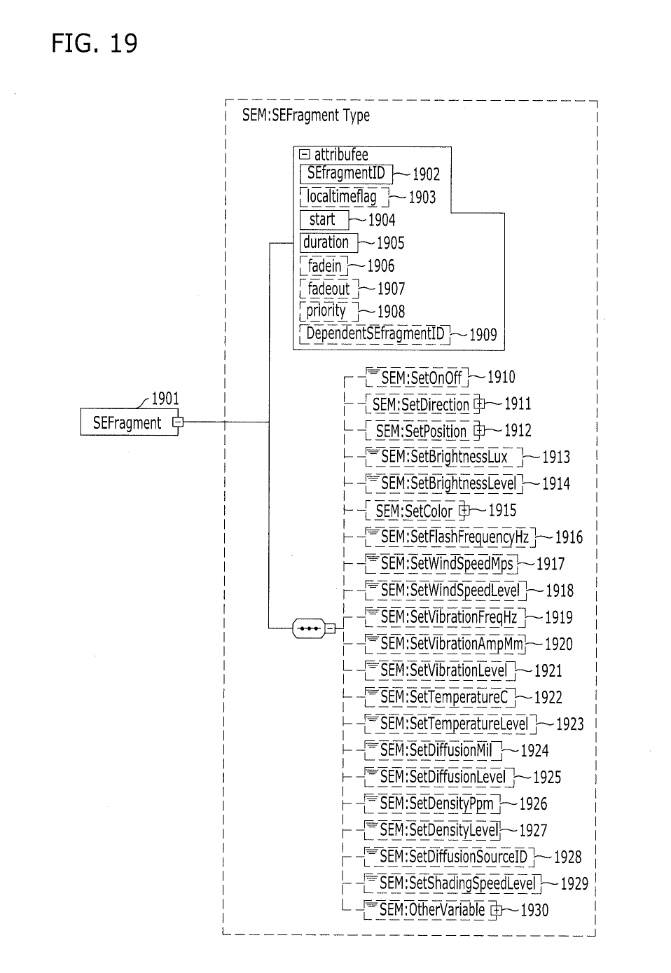

FIG. 19 is a diagram illustrating sensory effect fragment information (SEFragment) included in sensory effect metadata in accordance with an embodiment of the present invention.

The sensory effect fragment information (SEFragment) includes a small set of sensory effect variables which are inactivated and activated at the same time. Referring to FIG. 19, the sensory effect fragment information (SEFragment) 1901 includes following elements and attributes: SefragmentID 1902, localtimeflag 1903, start 1904, duration 1905, fadein 1906, fadeout 1907, priority 1908, and DependentSEfragmentID 1909.

The sensory effect fragment information (SEFragment) 1901 further includes following elements and attributes: SetOnOff 1910, SetDerection 1911, SetPosition 1912, SetBrightnessLux 1913, SetBrightnessLevel 1914, SetColor 1915, SetFlashFrequencyHz 1916, SetWindSpeedMps 1917, SetWindSpeedLevel 1918, SetVibrrationFreqHz 1919, SetVibrationAmpMm 1920, SetVibrationLevel 1921, SetTemperatureC 1922, SetTemperatureLevel 1923, SetDiffusionMil 1924, SetDiffusionLevel 1925, SetDensityPpm 1926, SetDensityLevel 1927, SetDiffusionSourceID 1928, SetShadingRange 1929, SetShadingSpeedLevel 1930, and OtherVariable 1931. Table 7 describes these elements and attributes in detail.

TABLE 7

| Name | Definition |
|---|---|
| SEfragmentID | An attribute defining ID of the fragment of the Sensory Effect. |
| localtimeflag | An optional attribute indicating whether start and duration is absolute time or |
| | relative time |
| start | An attribute defining the start time that Sensory Effect will be activated. The type |
| | is mpeg7:mediaTimePoint/Type. |
| duration | An attribute defining the duration time that Sensory Effect will be deactivated. |
| | The type is mpeg7:mediaDurationType. |
| fadein | An optional attribute defining the fade-in duration time that Sensory Effect will |
| | be dynamically showed up. The type is mpeg7:mediaDurationType. |
| | 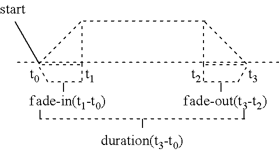 |
| fadeout | An optional attribute defining the fade-out duration time that Sensory Effect will |
| | be dynamically showed out. The type is mpeg7:mediaDurationType. |
| priority | An optional attribute defining the priority of Sensory Effect |
| DependentSEfrag- | An optional attribute defining dependency of current Sensory Effect fragment |
| mentID | For example, fragment ID 23 should be followed by fragment ID 21 |
| SetOnOff | An optional element for setting Sensory Effect on or off. The type is Boolean. |
| SetDirection | An optional element for setting the direction of Sensory Effect. The type is |
| | SEM:DirectionType (3.6) |
| SetPosition | An optional element for setting the position iof Sensory Effect. The type is |
| | SEM:PositionType (3.6) |
| SetBrightnessLUX | An optional element describing brightness of Sensory Effect in LUX. The type is |
| | SEM:LuxType. |
| SetBrightnessLevel | An optional element describing brightness of Sensory Effect in level. The type is |
| | SEM:LevelType. If MaxBrightnessLevel is defined, the value of this element |
| | should be restricted within the maximum value. Otherwise, the value will be |
| | within 0 to 100. |
| SetColor | An optional element defining the color of Sensory Effect. The type is |
| | SEM:ColorType (3.6) |
| SetFlickeringFre- | An optional element defining flickering frequency of Sensory Effect in Hz. The |
| quencyHz | type is SEM:freq hzType. |
| SetWindSpeedMps | An optional element defining wind speed of Sensory Effect in Meter per Second |
| | (Mps). The type is SEM:WindSpeedType |
| SetWindSpeed | An optional element defining wind speed of Sensory Effect in level. The type is |
| Level | SEM:LevelType. If MaxWindSpeedLevel is defined, the value of this element |
| | should be restricted within the maximum value. Otherwise, the value will be |
| | within 0 to 100. |
| SetVibration | An optional element defining vibration frequency of Sensory Effect in Hz. The |
| FreqHz | type is SEM:FreqType. |
| SetVibration | An optional element defining vibration amplitude of Sensory Effect in |
| AmpMm | Millimeter. The type is unsigned integer. |
| SetVibrationLevel | An optional element defining vibration intensity of Sensory Effect in level. The |
| | type is SEM:LevelType. If MaxVibrationLevel is defined, the value of this |
| | element should be restricted within the maximum value. Otherwide, the value will |
| | be within 0 to 100. |
| SetTemperature | An optional element defining temperature of Sensory Effect in Celsius. The type |
| | is SEM:TemperatureType. |
| SetTemperatureLevel | An optional element defining temperature setting level of Sensory Effect. The |
| | type is SEM:LevelType. If MaxTemperatureLevel is defined, the value of this |
| | element should be restricted within the maximum value. Otherwise, the value will |
| | be within 0 to 100. |
| SetDiffusionMil | An optional element defining diffusion quantity of Sensory Effect in Milligram |
| | per second. The type is SEM:DiffusionType. |
| SetDiffusion | An optional element defining diffusion level of Sensory Effect. The type is |
| Level | SEM:LevelType. If MaxDiffusionLevel is defind, the value of this element should |
| | be restricted within the maximum value. Otherwise, the value will be within 0 to |
| | 100. |
| SetDensityPpm | An optional element defining density of Sensory Effect in Ppm. The type is |
| | SEM:DiffusionType. |
| SetDensityLevel | An optional element defining density level of Sensory Effect. The type is |
| | SEM:LevelType. If MaxDensityLevel is defined, the value of this element should |
| | be restricted within the maximum value. Otherwise, the value will be within 0 to |
| | 100. |
| SetDiffusion | An optional element defining the source ID for diffusion |
| SourceID | |
| SetShadingRange | An optional element defining shading range from 0% to 100%. 0% means |
| | complete open and 100% means complete close. The type is SEM:LevelType. |
| SetShdingSpeedLevel | An optional element defining shading speed of Sensory Effect in level. The type |
| | is SEM:LevelType. |
| OtherVariable | 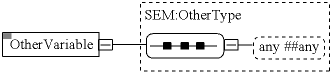 |

SefragmentID 1902 is an attribute defining an identifier of the fragment of a sensory effect. Localtimeflag 1903 is an optional attribute that indicates whether start and duration is an absolute time or a relative time. Start 1904 is an attribute defining a start time that a sensory effect is activated. A type of this attribute is mpeg7:mediaTimePointType. Duration 1905 is an attribute defining a duration time that a sensory effect is deactivated. A type of this attribute is mpeg7:mediaDurationType.

fadein 1906 is an optional attribute defining a fade0in duration time that a sensory effect will be dynamically showed up. A type of this optional attribute is mpeg7:mediaDurationType. fadeout 1907 is an optional attribute defining a fade-out duration time that a sensory effect will be dynamically showed out. A type of the optional attribute is mpeg7:mediaDurationType. Table 7 shows relation of a start time, a duration time, a fade-in, and a fade-out.

priority 1908 is an optional attribute defining a priority of a sensory effect. DependentSEfragmentID 1909 is an optional element dependency of a current sensory effect fragment. For example, a fragment ID 23 should be followed by a fragment ID 21.

SetOnOff 1910 is an optional element for on/off setting of a sensory effect. A type of the optional element is Boolean. SetDerection 1911 is an optional element for setting a direction of a sensory effect. A type of this element is DirectionType. SetPosition 1912 is an optional element for setting a position of a sensory effect. A type of this element is PositionType.

SetBrightnessLux 1913 is an optional element for describing brightness of a sensory effect in a unit of Lux. A type of this optional element is LuxType. SetBrightnessLevel 1914 is an optional element that describes brightness of a sensory effect in a unit of level. A type of this element is LevelType. If MaxBrightnessLevel is defined, a value of this element is limited by a maximum value. If not, it is in a range of 0 to 100.

SetColor 1915 is an optional element that defines a color of a sensory effect. A type is ColorType. SetFlashFrequencyHz 1916 is an optional element that defines a flash flickering frequency of a sensory effect in a unit of Hz. A type of this element is freq_hzType.

SetWindSpeedMps 1917 is an optional element that defines a wind speed of a sensory effect in Mps (Meter per second). A type of this element is WindSpeedType. SetWindSpeedLevel 1918 is an optional element that defines a wind speed of a sensory effect in a unit of level. A type of this element is LevelType. If MaxWindSpeedLevel is defined, a value of this element is limited by MaxWindSpeedLevel.

SetVibrrationFreqHz 1919 is an optional element defining a vibration frequency of a sensory effect in a unit of Hz. SetVibrationAmpMm 1920 is an optional element that defines amplitude of a sensory effect in a unit of millimeter. A type of this element is unsigned integer. SetVibrationLevel 1921 is an optional element that defines vibration intensity of a sensory effect in a unit of level. A type of this element is LevelType. If MaxVibrationLevel is defined, a value of SetVibrationLevel 1921 is limited by the value of MaxVibrationLevel. If not, the value of SetVibrationLevel 1921 is in a range of 0 to 100.

SetTemperatureC 1922 is an optional element that defines a temperature of a sensory effect in Celsius. A type of this element is TemperatureType. SetTemperatureLevel 1923 is an optional element that defines a temperature of a sensory effect in a unit of level. A type of this element is LevelType. If a value of MaxTemperatureLevel is defined, a value of SetTemperatureLevel 1923 is limited by the value of MaxTemperatureLevel. If not, the value of SetTemperatureLevel 1923 is in a range of 0 to 100.

SetDiffusionMil 1924 is an optional element that defines a diffusion quantity of a sensory effect in a unit of milligram per second. SetDiffusionLevel 1925 is an optional element that defines a diffusion level of a sensory effect. A type of SetDiffusionLevel 1925 is LevelType. If MaxDiffusionLevel is defined, a value of SetDiffusionLevel 1925 is limited by MaxDiffusionLevel. If not, the value of SetDiffusionLevel 1925 is in a range of 0 to 100.

SetDensityPpm 1926 is an optional element that defines a density of a sensory effect in a unit of ppm. A type of this element is DiffusionType. SetDensityLevel 1927 is an optional element that defines a density level of a sensory effect. A type of this element is LevelType. If MaxDensityLevel is defined, a value of SetDensityLevel 1927 is limited within a maximum value set by MaxDensityLevel. If not, the value of SetDensityLevel 1927 is in a range of 0 to 100.

SetDiffusionSourceID 1928 is an optional element that defines a source identifier for diffusion.

SetShadingRange 1929 is an optional element defining a shading range of 0% to 100%. 0% denotes completely open and 100% denotes completely close. A type of SetShadingRange 1929 is LevelType. SetShadingSpeedLevel 1930 is an optional element that defines a shading speed of a sensory effect in a level unit. A type of SetShadingSpeedLevel 1930 is LevelType.

OtherVariable 1931 is an optional element for expandable sensory effect variable.

A schema for the sensory effect fragment information (SEFragment) of FIG. 19 is exemplary shown as follows.

```
<element name=“SEFragment” type=“SEM:SEFragmentType”/>
    <complexType name=“SEFragmentType”>
        <sequence>
```

| | |
|---|---|
| <element name=“SetOnOff” | type=“boolean” |
| minOccurs=“0”/> | |
| <element | name=“SetDirection” |
| type=“SEM:DirectionType” minOccurs=“0”/> | |
| <element | name=“SetPosition” |
| type=“SEM:PositionType” minOccurs=“0”/> | |

| | |
|---|---|
| <element | name=“SetBrightnessLux” |
| type=“SEM:LuxType” minOccurs=“0”/> | |
| <element | name=“SetBrightnessLevel” |
| type=“SEM:LevelType” minOccurs=“0”/> | |

<element name=“SetColor” type=“SEM:ColorType”
minOccurs=“0”/>

| | |
|---|---|
| <element | name=“SetFlickeringFrequencyHz” |

type=“SEM:FreqType” minOccurs=“0”/>

| | |
|---|---|
| <element | name=“SetWindSpeedMps” |

type=“SEM:WindSpeedType” minOccurs=“0”/>

| | |
|---|---|
| <element | name=“SetWindSpeedLevel” |

type=“SEM:LevelType” minOccurs=“0”/>

| | |
|---|---|
| <element | name=“SetVibrationRpm” |

type=“SEM:VibrationType” minOccurs=“0”/>

| | |
|---|---|
| <element | name=“SetVibrationLevel” |

type=“SEM:LevelType” minOccurs=“0”/>

| | |
|---|---|
| <element | name=“SetTemperatureC” |

type=“SEM:TemperatureType” minOccurs=“0”/>

| | |
|---|---|
| <element | name=“SetTemperatureLevel” |

type=“SEM:LevelType” minOccurs=“0”/>

| | |
|---|---|
| <element | name=“SetDiffusionMil” |
| type=“SEM:DiffusionType” minOccurs=“0”/> | |

| | |
|---|---|
| <element | name=“SetDiffusionLevel” |
| type=“SEM:LevelType” minOccurs=“0”/> | |
| <element | name=“SetDensityPpm” |
| type=“SEM:DensityType” minOccurs=“0”/> | |
| <element | name=“SetDensityLevel” |
| type=“SEM:LevelType” minOccurs=“0”/> | |

| | |
|---|---|
| <element | name=“SetDiffusionSourceID” |
| type=“ID” minOccurs=“0”/> | |
| <element | name=“SetShadingRange” |

type=“SEM:LevelType” minOccurs=“0”/>

| | |
|---|---|
| <element | name=“SetShadingSpeedLevel” |

type=“SEM:LevelType” minOccurs=“0”/>

| | |
|---|---|
| <element | name=“OtherVariable” |
| type=“SEM:OtherType” minOccurs=“0”/> | |
| </sequence> | |

<attribute name=“SEfragmentID” type=“ID” use=“required”/>

| | |
|---|---|
| <attribute name=“localtimeflag” | type=“boolean” |
| use=“optional”/> | |

| | |
|---|---|
| <attribute | name=“start” |
| type=“mpeg7:mediaTimePointType” use=“required”/> | |
| <attribute | name=“duration” |
| type=“mpeg7:mediaDurationType” use=“required”/> | |
| <attribute | name=“fadein” |
| type=“mpeg7:mediaDurationType” use=“optional”/> | |
| <attribute | name=“fadeout” |
| type=“mpeg7:mediaDurationType” use=“optional”/> | |

| | |
|---|---|
| <attribute name=“priority” | type=“unsignedInt” |
| use=“optional”/> | |

| | |
|---|---|
| <attribute | name=“DependentSEfragmentID” |
| type=“IDREF” use=“optional”/> | |
| </complexType> | |

Table 8 describes simple type in detail. It is necessary to restrict an intensity value of sensory effect for safety purpose. In the present embodiment, a simple type for each sensory effect measurement unit is defined and it is referred in user sensory preference metadata.

TABLE 8

| Name | Definition & Source |
|---|---|
| LuxType | This simple type represents degree of brightness using lux. The restriction base |
| | is snvt:luxType. The value is restricted from 0 to 5000 lux. |
| | <simpleType name=“LuxType”> |
| | <restriction base=“snvt:luxType”> |
| | <maxInclusive value=“5000”/> |
| | </restriction> |
| | </simpleType> |
| FreqType | This simple type represents maximum frequency using Hz. The restriction base |
| | is snvt:freq_hzType. The value is restricted from 0 to 1000. |
| | <simpleType name=“FreqType”> |
| | <restriction base=“snvt:freq_hzType”> |
| | <minInclusive value=“0”/> |
| | <maxInclusive value=“1000”/> |
| | </restriction> |
| | </simpleType> |
| MaxTemperatureType | This simple type represents maximum temperature using centigrade. The |
| | restriction base is snvt:temp_pType. The value is restricted from 0 to 45. |
| | <simpleType name=“MaxTemperatureType”> |
| | <restriction base=“snvt:temp_pType”> |
| | <minInclusive value=“0”/> |
| | <maxInclusive value=“45”/> |
| | </restriction> |
| | </simpleType> |
| MinTemperatureType | This simple type represents minimum temperature using centigrade. The |
| | restriction base is snvt:temp_pType. The value is restricted from −15 to 0. |
| | <simpleType name=“MinTemperatureType”> |
| | <restriction base=“snvt:temp_pType”> |
| | <minInclusive value=“−15”/> |
| | <maxInclusive value=“0”/> |
| | </restriction> |
| | </simpleType> |
| TemperatureType | This simple type represents temperature using centigrade. |
| | <simpleType name=“TemperatureType”> |
| | <restriction base=“snvt:temp_pType”> |
| | <minInclusive value=“−15”/> |
| | <maxInclusive value=“45”/> |
| | </restriction> |
| | </simpleType> |
| WindSpeedType | This simple type represents speed of wind using meter per second. The |
| | restriction base is snvt:speed_milType. The value is restricted from 0 to |
| | 20 mps. |
| | <simpleType name=“WindSpeedType”> |
| | <restriction base=“snvt:speed_milType”> |
| | <maxInclusive value=“20”/> |
| | </restriction> |
| | </simpleType> |
| TurnSpeedType | This simple type represents turning speed using velocity. The restriction base is |
| | snvt:angle_velType. The value is restricted from 0 to 10 |
| | <simpleType name=“TurnSpeedType”> |
| | <restriction base=“snvt:angle_velType”> |
| | <minInclusive value=“0”/> |
| | <maxInclusive value=“10”/> |
| | </restriction> |
| | </simpleType> |
| DiffusionType | This simple type represents mass using milligram. The restriction base is |
| | snvt:mass_milType. The value is restricted from 0 to 200. |
| | <simpleType name=“DiffusionType”> |
| | <restriction base=“snvt:mass_milType”> |
| | <maxInclusive value=“200”/> |
| | </restriction> |
| | </simpleType> |
| DensityType | This simple type represents density using ppm. The restriction base is |
| | snvt:ppmType. The value is restricted from 0 to 10000. |
| | <simpleType name=“DensityType”> |
| | <restriction base=“snvt:ppmType”> |
| | <maxInclusive value=“10000”/> |
| | <restriction> |
| | <simpleTye> |
| LevelType | This simple type represents percentage. The value is restricted from 0 to 100. |
| | <simpleType name=“LevelType”> |
| | <restriction base=“unsignedInt”> |
| | <minInclusive value=“0”/> |
| | <maxInclusive value=“100”/> |
| | </restriction> |
| | </simpleType> |
| VibrationType | This simple type represents intensity of vibration using rpm. The restriction base |
| | is snvt:rmp Type. The value is restricted from 0 to 20000. |
| | <simpleType name=“VibrationType”> |
| | <restriction base=“snvt:rpm_Type”> |
| | <maxInclusive value=“20000”/> |
| | </restriction> |
| | </simpleType> |

Hereinafter, a definition and semantic of a SNVT schema related to LonWorks will be described.

LonWorks provides an open networking platform formed of a protocol designed by Echelon Corporation for networking devices connected through twisted pairs, power lines and fiber optics. LonWorks defines (1) a dedicated microprocessor known as an neuron chip which is highly optimized for devices on control network, (2) a transceiver for transmitting protocols on predetermined media such as twisted pairs or power lines, (3) a network database which is an essential software component of an open control system (which is also known as LNS network operating system), and (4) internet connection with standard network variable types (SNVTs). One of elements for interoperability in LonWorks is the standardization of SNVTs. For example, a thermostat using temperature SNVT has values between 0 to 65535 which are equivalent to a temperature range of −274° C. to 6279.5° C. DRESS media is rendered through devices that can be controlled by media metadata for special effect. A metadata schema for describing special effects may be designed based on a restricted set of SNVT data type for device control. Table 9 shows SNVT expression in LonWorks.

TABLE 9
SNVT_angle_deg (104)
Phase/Rotation

| SNVT Index | Measurement | Type Category | Type Size |
|---|---|---|---|
| 104 | Angular distance | Signed Long | 2 bytes |

| Valid Type Range | Type Resolution | Units | Invalid Value |
|---|---|---|---|
| −359.98 . . . 360.00 | 0.02 | degrees | 32,767 (0x7FFF) |

| | | | Default |
|---|---|---|---|
| Raw Range | Scale Factors | File Name | Value |
| −17,999 . . . 18,000 | 2, −2, 0 | N/A | N/A |
| (0xB9B1 . . . 0x4650) | S = a*10^{b}*(R + c) | | |

In Table 9, boxes surrounded with a bold line are translated to a XML schema. The box Type Category expresses a variable type using predefined variable types such as unsignedInt, float, decimal and Boolean. The box Valid type Range limits a range of values and the box Type Resolution defines a resolution to express a value. The box Units denotes a unit to express SNVT type. In case of SNVT_angle_deg, a proper unit thereof is degrees.

Table 10 describes SNVTs translated to XML schema.

TABLE 10

| SNVT | Definition | | | |
|---|---|---|---|---|
| SNVT_lux | SNVT_lux describes illumination using lux. The type of SNVT_lux is snvt:luxType. | | | |
| | The following table is provided in LonMark web site. | | | |
| | Illumination (luminous-flux intensity) | | | |
| | 1 lux = 1 lumen · m² | | | |
| | As a comparison: 1 foot-candle = 1 lumen/ft². 1 foot-candle = 10.76 lux. | | | |
| | SNVT Index | Measurement | Type Category | Type Size |
| | 79 | Illumination | Unsigned Long | 2 bytes |
| | Valid Type Range | Type Resolution | Units | Invalid Value |
| | 0 . . . 65,335 | 1 | Lux | |
| | Raw Range | Scale Factors | File Name | Default Value |
| | 0 . . . 65,535 | 1, 0, 0 | N/A | N/A |
| | (0 . . . 0xFFFF) | S = a*10^{b}*(R + c) | | |

According to the definition, we design snvt:luxType.

<simpleType name=“luxType”>

<restriction base=“unsignedInt”>

<minInclusive value=“0”/>
<maxInclusive value=“65534”/>

</restriction>

</simpleType>

| SNVT_speed_mil | SNVT_speed_mil describes linear velocity as m/s(meters/sec). The type of | | | |
|---|---|---|---|---|
| | SNVT_speed_mil is snvt:speed_milType. | | | |
| | Linear Velocity | | | |
| | SNVT Index | Measurement | Type Category | Type Size |
| | 35 | Linear Velocity | Unsigned Long | 2 bytes |
| | Valid Type Range | Type Resolution | Units | Invalid Value |
| | 0 . . . 65,535 | 0.001 | Meters per Second | |
| | | | (m/s) | |
| | Raw Range | Scale Factors | File Name | Default Value |
| | 0 . . . 65,535 | 1, −3, 0 | N/A | N/A |
| | (0 . . . 0xFFFF) | S = a*10^{b}*(R + c) | | |

According to the definition, we design snvt:speed_milType.

<simpleType name=“speed_milType”>

<restriction base=“float”>

<minInclusive value=“0”/>
<maxInclusive value=“65,535”/>
<fractionDigits value=“3”/>

</restriction>

</simpleType>

| SNVT_angle_deg | SNVT_angle_deg describes degree for phase and rotation. The type of | | | |
|---|---|---|---|---|
| | SNVT_angle_deg is snvt:angle_degType. | | | |
| | Phase/Rotation | | | |
| | SNVT Index | Measurement | Type Category | Type Size |
| | 104 | Angular distance | Signed Long | 2 bytes |
| | Valid Type Range | Type Resolution | Units | Invalid Value |
| | −359.98 . . . 360.00 | 0.02 | degrees | 32,767 (0x7FFF) |
| | Raw Range | Scale Factors | File Name | Default Value |
| | −17.999 . . . 18,000 | 2, −2, 0 | N/A | N/A |
| | (0xB9B1 . . . 0x4650) | S = a*10^{b}*(R + c) | | |

<simpleType name=“temp_pType”>

<restriction base=“decimal”>

<minInclusive value=“−273.17”/>
<maxInclusive value=“327.66”/>
<fractionDigits value=“2”/>

</restriction>

</simpleType>

| SNVT_rpm | SNVT_rpm describes angular velocity with rotation per minutes. The type of | | | |
|---|---|---|---|---|
| | SNVT_rpm is snvt:rpm_Type. | | | |
| | Angular Velocity | | | |
| | SNVT Index | Measurement | Type Category | Type Size |
| | 102 | Angular Velocity | Unsigned Long | 2 bytes |
| | Valid Type Range | Type Resolution | Units | Invalid Value |
| | 0 . . . 65,534 | 1 | Revolutions per Minute | 65,535 (0xFFFF) |
| | | | (RPM) | |
| | Raw Range | Scale Factors | File Name | Default Value |
| | 0 . . . 65,534 | 1, 0, 0 | N/A | N/A |
| | (0 . . . 0xFFFE) | S = a*10^{b}*(R + c) | | |

According to the definition, we design snvt:rpm_Type.

<simpleType name=“rpm_Type”>

<restriction base=“unsignadInt”>

<minInclusive value=“0”/>
<maxInclusive value=“65534”/>

</restriction>

</simpleType>

The present application contains a subject matter related to U.S. Patent Application No. 61/081,358, filed in the United States Patent and Trademark Office on Jul. 16, 2008, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

What is claimed is:

1. A method for generating sensory effect media, comprising:
receiving sensory effect information about sensory effects applied to media; and
generating sensory effect metadata including the received sensory effect information,
wherein the sensory effect metadata includes sensory effect description information for describing the sensory effects and the sensory effect description information includes media location information that describes locations in the media where the sensory effects are applied to.

2. The method of claim 1, further comprising: transmitting the sensory effect metadata to an apparatus for representing sensory effects.

3. The method of claim 1, wherein the sensory effect description information further includes sensory effect segment information applied to segments of the media.

4. The method of claim 3, wherein the sensory effect segment information includes effect list information about a list of sensory effects applied to the segments, effect variable information, and segment location information that describes locations in the segments where the sensory effects are applied to.

5. The method of claim 4, wherein the effect variable information includes sensory effect fragment information having at least one of sensory effect variables that are applied at the same time.

6. An apparatus for generating sensory media, comprising:
an input unit configured to receive sensory effect information about sensory effects applied to media; and
a sensory effect metadata generator configured to generate sensory effect metadata including the received sensory effect information,
wherein the sensory effect metadata includes sensory effect description information for describing the sensory effects and the sensory effect description information includes media location information that describes locations in the media where the sensory effects are applied to.

7. The apparatus of claim 6, wherein the sensory effect description information further includes sensory effect segment information applied to segments of the media.

8. The apparatus of claim 7, wherein the sensory effect segment information includes effect list information about a list of sensory effects applied to the segments, effect variable information, and segment location information that describes locations in the segments where the sensory effects are applied to.

9. The apparatus of claim 8, wherein the effect variable information includes sensory effect fragment information including at least one of sensory effect variables that are applied at the same time.

10. A method for representing sensory effects, comprising:
receiving sensory effect metadata including sensory effect information about sensory effects applied to media;
obtaining the sensory effect information by analyzing the sensory effect metadata; and
generating sensory device command metadata for controlling sensory devices corresponding to the sensory effect information,
wherein the sensory effect metadata includes sensory effect description information for describing the sensory effects, and the sensory effect description information includes media location information that describes locations in the media where the sensory effects are applied to.

11. The method of claim 10, wherein the sensory effect description information further includes sensory effect segment information applied to segments of the media.

12. The method of claim 11, wherein the sensory effect segment information includes effect list information applied to the segments, effect variable information, and segment location information that describes locations in the segments where the sensory effects are applied to.

13. The method of claim 12, wherein the effect variable information includes sensory effect fragment information including at least one of sensory effect variables that are applied at the same time.

14. An apparatus for representing sensory effects, comprising:
an input unit configured to receive sensory effect metadata including sensory effect information about sensory effects applied to media; and
a controlling unit configured to obtain the sensory effect information by analyzing the sensory effect metadata and generate sensory device command metadata for controlling sensory devices corresponding to the sensory effect information,
wherein the sensory effect metadata includes sensory effect description information that describes the sensory effects, and the sensory effect description information includes media location information that describes locations in the media where the sensory effects are applied to.

15. A computer readable recording medium storing metadata, the metadata comprising:
sensory effect metadata including sensory effect information about sensory effects applied to media,
wherein the sensory effect metadata includes sensory effect description information that describes the sensory effects and media location information that describes locations in the media where the sensory effects are applied to.
